(19) United States
(12) Patent Application Publication
(10) Pub. No.: US 2025/0148948 A1
(43) Pub. Date: May 8, 2025

(54) ELECTRONIC DEVICE, METHOD, AND NON-TRANSITORY COMPUTER READABLE STORAGE MEDIUM FOR DISPLAYING CONTENT ON FLEXIBLE DISPLAY

(71) Applicant: SAMSUNG ELECTRONICS CO., LTD., Suwon-si (KR)

(72) Inventors: Sujeong CHO, Suwon-si (KR); Hyoungtak CHO, Suwon-si (KR); Yangwook KIM, Suwon-si (KR); Bonghak CHOI, Suwon-si (KR); Sunghoon LEE, Suwon-si (KR); Soyoung LEE, Suwon-si (KR); Meeryung CHOI, Suwon-si (KR)

(73) Assignee: SAMSUNG ELECTRONICS CO., LTD., Suwon-si (KR)

(21) Appl. No.: 18/886,514

(22) Filed: Sep. 16, 2024

Related U.S. Application Data
(63) Continuation of application No. PCT/KR2024/012017, filed on Aug. 12, 2024.

(30) Foreign Application Priority Data
Nov. 7, 2023 (KR) 10-2023-0153167
Dec. 19, 2023 (KR) 10-2023-0186434

(51) Int. Cl. G09G 3/00; G06F 1/16

(52) U.S. Cl. CPC G09G 3/035; G06F 1/1652; G09G 2340/0464; G09G 2354/00

(57) ABSTRACT

An electronic device is configured to display a plurality of contents in a display area of a flexible display while the size of the display area is a first size, and based on the size of the display area increasing from the first size to a second size: display, in a first area among areas of the display area, first content related to content selected from among the plurality of contents while the display area has the first size, wherein the areas are arranged with respect to each other; and display, in a second area and a third area among the areas, at least a part of second content and at least a part of third content, respectively, wherein the first area is between and adjacent to the second area and the third area.

### CROSS-REFERENCE TO RELATED APPLICATIONS

This application is a continuation application claiming priority to International Application No. PCT/KR2024/012017, filed on Aug. 12, 2024, which is based on and claims the benefit of Korean Patent Application No. 10-2023-0153167, filed on Nov. 7, 2023, in the Korean Intellectual Property Office, and Korean Patent Application No. 10-2023-0186434, filed on Dec. 19, 2023, in the Korean Intellectual Property Office, the disclosure of each of which is incorporated by reference herein in its entirety.

### BACKGROUND

### 1. Field

Embodiments of the present disclosure relate to an electronic device, a method, and a non-transitory computer readable storage medium for displaying content on a flexible display.

### 2. Brief Description of Background Art

Recently, electronic devices including flexible displays are appearing. The flexible display may be wound or unwound inside the electronic device due to the flexible display being able to be freely bent. As the flexible display is wound inside the electronic device, a size or extent of the entire viewable display may be reduced, and as the flexible display wound inside the electronic device is unwound, the size or extent of the entire viewable display may increase.

### SUMMARY

According to embodiments of the present disclosure, an electronic device may be provided and include: a housing including a first housing part and a second housing part movably engaged with the first housing part; a flexible display including a display area visible from a front of the electronic device, wherein a size of the display area is enlarged or reduced according to a movement of the second housing part; a memory storing instructions; and a processor operatively connected to the flexible display and the memory, wherein the instructions are configured to, when executed by the processor, cause the electronic device to: display a plurality of contents in the display area while the size of the display area of the flexible display is a first size; and based on the size of the display area increasing from the first size to a second size: display, in a first area among areas of the display area, first content related to content selected from among the plurality of contents while the display area has the first size, wherein the areas are arranged with respect to each other; and display, in a second area and a third area among the areas, at least a part of second content and at least a part of third content, respectively, wherein the first area is between and adjacent to the second area and the third area, and wherein the at least the part of the second content and the at least the part of the third content are respectively displayed, while the size of the display area is increasing to the second size, around where the content that is selected was displayed while the display area has the first size.

According to embodiments of the present disclosure, a method performed by the electronic device may be provided and include: displaying a plurality of contents in the display area while the size of the display area of the flexible display is a first size; and based on the size of the display area increasing from the first size to a second size: displaying, in a first area among areas of the display area, first content related to content selected from among the plurality of contents while the display area has the first size, wherein the areas are arranged with respect to each other; and displaying, in a second area and a third area among the areas, at least a part of second content and at least a part of third content, respectively, wherein the first area is between and adjacent to the second area and the third area, and wherein the at least the part of the second content and the at least the part of the third content are respectively displayed, while the size of the display area is increasing to the second size, around where the content that is selected was displayed while the display area has the first size.

According to embodiments of the present disclosure, a non-transitory computer readable storage medium storing a program including instructions may be provided. The instructions may be configured to, when executed by a processor of the electronic device: display a plurality of contents in the display area while the size of the display area of the flexible display is a first size; and based on the size of the display area increasing from the first size to a second size: display, in a first area among areas of the display area, first content related to content selected from among the plurality of contents while the display area has the first size, wherein the areas are arranged with respect to each other; and display, in a second area and a third area among the areas, at least a part of second content and at least a part of third content, respectively, wherein the first area is between and adjacent to the second area and the third area, and wherein the at least the part of the second content and the at least the part of the third content are respectively displayed, while the size of the display area is increasing to the second size, around where the content that is selected was displayed while the display area has the first size.

### BRIEF DESCRIPTION OF DRAWINGS

FIG. 1 is a block diagram of an electronic device in a network environment according to various embodiments.

FIG. 2A is a top plan view of an example electronic device in a first state.

FIG. 2B is a bottom view of an example electronic device in a first state.

FIG. 2C is a top plan view of an example electronic device in a second state.

FIG. 2D is a bottom view of an example electronic device in a second state.

FIG. 3A is an exploded perspective view of an example electronic device.

FIG. 3B is an exploded perspective view of an example electronic device.

FIG. 4A is a cross-sectional view of an example electronic device in a first state.

FIG. 4B is a cross-sectional view of an example electronic device in a second state.

FIG. 5 is a schematic block diagram of an electronic device.

FIG. 6A is a diagram illustrating an example of a layout of a user interface (UI) displayed in a reduced state of an electronic device according to an embodiment.

FIG. 6B is a diagram illustrating an example of a layout of a UI displayed in an extended state of an electronic device according to an embodiment.

FIG. 6C is a diagram illustrating an example of a layout of a UI displayed in an extended state of an electronic device according to an embodiment.

FIG. 6D is a diagram illustrating an example of a layout of a UI displayed in an extended state of an electronic device according to an embodiment.

FIG. 7A is a diagram illustrating an example of a layout of a UI displayed in an extended state of an electronic device according to an embodiment.

FIG. 7B is a diagram illustrating an example of a layout of a UI displayed in an extended state of an electronic device according to an embodiment.

FIG. 7C is a diagram illustrating an example of a layout of a UI displayed in an extended state of an electronic device according to an embodiment.

FIG. 8 is a diagram illustrating an example of a change in a layout of a UI according to a change from a reduced state to an extended state of an electronic device according to an embodiment.

FIG. 9 is a diagram illustrating an example of a change in a layout of a UI according to a change from a reduced state to an extended state of an electronic device according to an embodiment.

FIG. 10 is a diagram illustrating an example of a change in a layout of a UI according to a change from a reduced state to an extended state of an electronic device according to an embodiment.

FIG. 11 is a diagram illustrating an example of a change in a layout of a UI according to a change from a reduced state to an extended state of an electronic device according to an embodiment.

FIG. 12 is a diagram illustrating an example of a change in a layout of a UI according to a change from a reduced state to an extended state of an electronic device according to an embodiment.

FIG. 13 is a flowchart illustrating an operation of an electronic device according to an embodiment.

FIG. 14 is a flowchart illustrating an operation of an electronic device according to an embodiment.

FIG. 15 is a flowchart illustrating an operation of an electronic device according to an embodiment.

### DETAILED DESCRIPTION

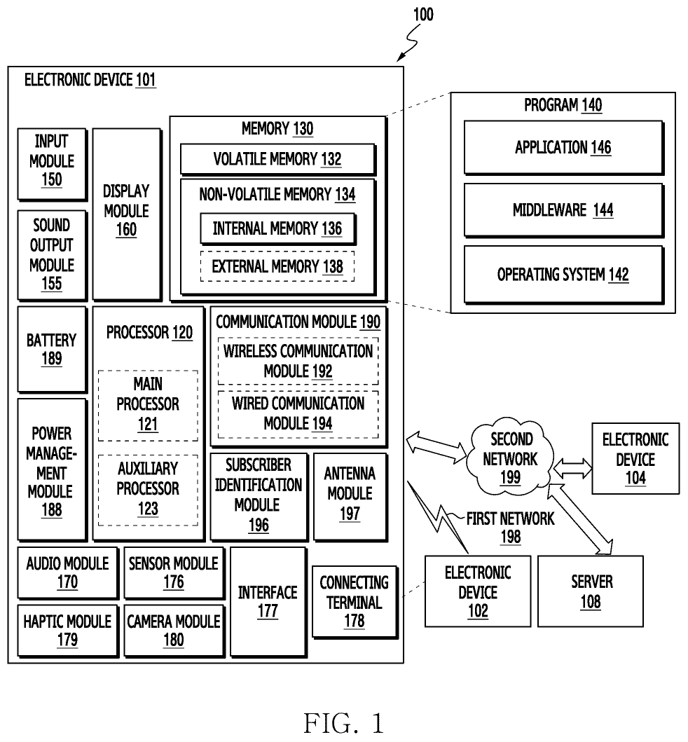

FIG. 1 is a block diagram illustrating an electronic device 101 in a network environment 100 according to various embodiments.

Referring to FIG. 1, the electronic device 101 in the network environment 100 may communicate with an electronic device 102 via a first network 198 (e.g., a short-range wireless communication network), and/or at least one from among an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, and/or an antenna module 197. In some embodiments, at least one of the components (e.g., the connecting terminal 178) may be omitted from the electronic device 101, and/or one or more other components may be added in the electronic device 101. In some embodiments, some of the components (e.g., the sensor module 176, the camera module 180, and/or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing and/or computation. According to an embodiment, as at least part of the data processing and/or computation, the processor 120 may store a command and/or data received from another component (e.g., the sensor module 176 or the communication module 190) in volatile memory 132, process the command and/or the data stored in the volatile memory 132, and store resulting data in non-volatile memory 134. According to an embodiment, the processor 120 may include a main processor 121 (e.g., a central processing unit (CPU) and/or an application processor (AP)), and/or an auxiliary processor 123 (e.g., a graphics processing unit (GPU), a neural processing unit (NPU), an image signal processor (ISP), a sensor hub processor, and/or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of, the main processor 121.

The auxiliary processor 123 may control at least some of functions and/or states related to at least one component (e.g., the display module 160, the sensor module 176, and/or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, for example, by the electronic device 101 where the artificial intelligence is performed or via a separate server (e.g., the server 108). Learning algorithms may include, but are not limited to, for example, supervised learning, unsupervised learning, semi-supervised learning, and/or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 and/or the sensor module 176) of the electronic device 101. The various data may include, for example, software (e.g., the program 140) and input data and/or output data for a command related thereto. The memory 130 may include the volatile memory 132 and/or the non-volatile memory 134.

The program 140 may be stored in the memory 130 as software, and may include, for example, an operating system (OS) 142, middleware 144, and/or an application 146.

The input module 150 may receive a command and/or data to be used by another component (e.g., the processor 120) of the electronic device 101, from the outside (e.g., a user) of the electronic device 101. The input module 150 may include, for example, a microphone, a mouse, a keyboard, a key (e.g., a button), and/or a digital pen (e.g., a stylus pen).

The sound output module 155 may output sound signals to the outside of the electronic device 101. The sound output module 155 may include, for example, a speaker and/or a receiver. The speaker may be used for general purposes, such as playing multimedia and/or playing a record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, and/or a projector and control circuitry to control a corresponding one of the display, hologram device, and projector. According to an embodiment, the display module 160 may include a touch sensor adapted to detect a touch, and/or a pressure sensor adapted to measure the intensity of force incurred by the touch.

The audio module 170 may convert a sound into an electrical signal and vice versa. According to an embodiment, the audio module 170 may obtain the sound via the input module 150, and/or output the sound via the sound output module 155 and/or a headphone of an external electronic device (e.g., an electronic device 102) directly (e.g., wiredly) or wirelessly coupled with the electronic device 101.

The sensor module 176 may detect an operational state (e.g., power and/or temperature) of the electronic device 101 and/or an environmental state (e.g., a state of a user) external to the electronic device 101, and then generate an electrical signal and/or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, and/or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, and/or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, a SD card connector, and/or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, and/or an electric stimulator.

The camera module 180 may capture a still image or moving images. According to an embodiment, the camera module 180 may include one or more lenses, image sensors, image signal processors, and/or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, and/or a fuel cell.

The communication module 190 may support establishing a direct (e.g., wired) communication channel and/or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, and/or a global navigation satellite system (GNSS) communication module) and/or a wired communication module 194 (e.g., a local area network (LAN) communication module and/or a power line communication (PLC) module). A corresponding one of these communication modules may communicate with the external electronic device via the first network 198 (e.g., a short-range communication network, such as Bluetooth™, wireless-fidelity (Wi-Fi) direct, and/or infrared data association (IrDA)) and/or the second network 199 (e.g., a long-range communication network, such as a legacy cellular network, a 5G network, a next-generation communication network, the Internet, and/or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, for example, new radio (NR) access technology. The NR access technology may support enhanced mobile broadband (eMBB), massive machine type communications (mMTC), and/or ultra-reliable and low-latency communications (URLLC). The wireless communication module 192 may support a high-frequency band (e.g., the mmWave band) to achieve, for example, a high data transmission rate. The wireless communication module 192 may support various technologies for securing performance on a high-frequency band, such as, for example, beamforming, massive multiple-input and multiple-output (massive MIMO), full dimensional MIMO (FD-MIMO), array antenna, analog beam-forming, and/or a large scale antenna. The wireless communication module 192 may support various requirements specified in the electronic device 101, an external electronic device (e.g., the electronic device 104), and/or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit and/or receive a signal and/or power to or from the outside (e.g., the external electronic device) of the electronic device 101. According to an embodiment, the antenna module 197 may include an antenna including a radiating element composed of a conductive material and/or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted and/or received between the electronic device 101 and the electronic device 104 via the server 108 coupled with the second network 199. Each of the electronic device 102 and the electronic device 104 may be a device of a same type as, or a different type, from the electronic device 101. According to an embodiment, all or some of operations to be executed at the electronic device 101 may be executed at one or more from among the electronic device 102, the electronic device 104, and the server 108. For example, if the electronic device 101 should perform a function and/or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), and/or client-server computing technology may be used, for example. The electronic device 101 may provide ultra low-latency services using, for example, distributed computing and/or mobile edge computing. In another embodiment, the electronic device 104 may include an internet-of-things (IoT) device. The server 108 may be an intelligent server using machine learning and/or a neural network. According to an embodiment, the electronic device 104 and/or the server 108 may be included in the second network 199. The electronic device 101 may be applied to intelligent services (e.g., smart home, smart city, smart car, or healthcare) based on 5G communication technology or IoT-related technology.

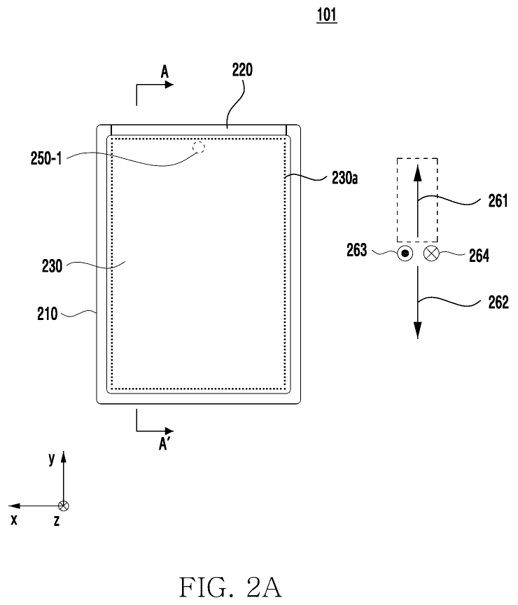

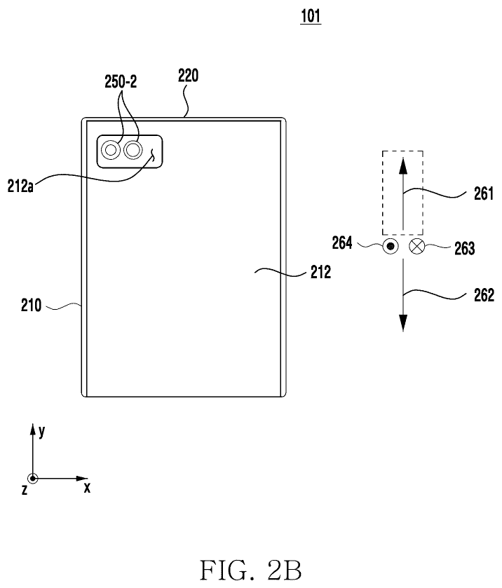

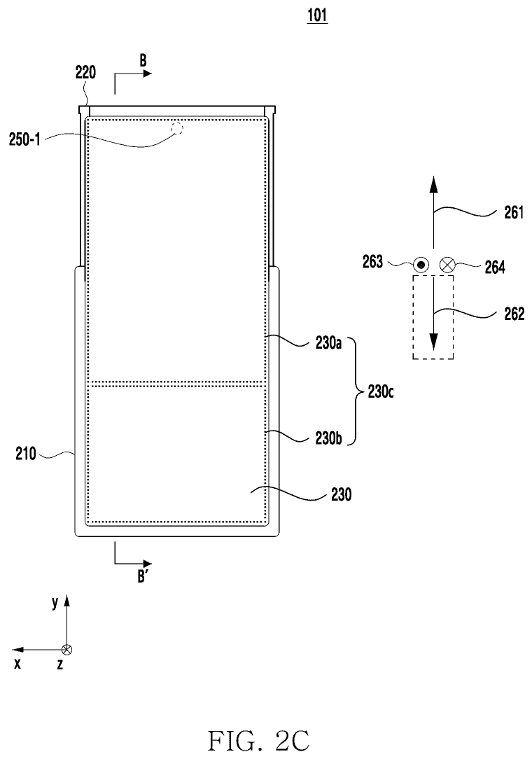

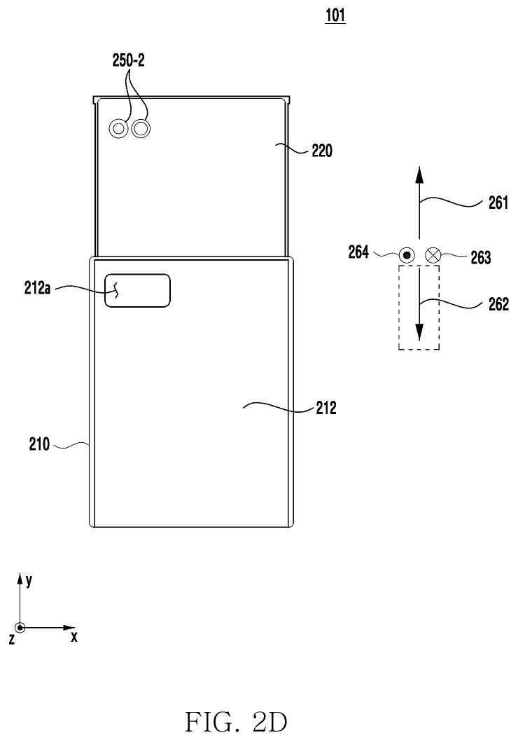

FIG. 2A is a top plan view of an example electronic device in a first state.

Referring to FIG. 2A, according to an embodiment, the electronic device 101 may include a first housing part 210, a second housing part 220 that is movable relative to the first housing part 210 in a first direction 261 parallel to the y-axis or a second direction 262 parallel to the y-axis and opposite to the first direction 261, and a display 230 (e.g., the display module 160 of FIG. 1).

For example, the electronic device 101 may be in the first state. For example, in the first state, the second housing part 220 may be movable relative to the first housing part 210 in the first direction 261. For example, in the first state, the second housing part 220 may not be movable in the second direction 262 relative to the first housing part 210.

For example, in the first state, the display 230 may provide a display area smaller than a display area of another state (e.g., the second state). For example, in the first state, the display area may correspond to an area 230a. For example, in the first state, an area (e.g., an area 230b of FIG. 2C) of the display 230 that is different from the area 230a that is the display area may be included in the first housing part 210. For example, in the first state, the area (e.g., the area 230b of FIG. 2C) may be covered by the first housing part 210. For example, in the first state, the area may be rolled into the first housing part 210. For example, in the first state, the area 230a may include a planar portion and not a curved portion. However, it is not limited thereto. For example, the area 230a may include a curved portion extending from the planar portion and located in an edge portion in the first state.

For example, the first state may be referred to as a slide-in state or a closed state in terms of that at least a part of the second housing part 220 is located in the first housing part 210. For example, the first state may be referred to as a reduced state in terms of providing the display area having the smallest size. However, it is not limited thereto.

For example, the first housing part 210 may include a first image sensor 250-1 in a camera module 180 (see FIG. 1) exposed through a part of the area 230a and facing a third direction 263 parallel to a z-axis. For example, the second housing part 220 may include one or more second image sensors in a camera module 180, exposed through a part of the second housing part 220 and facing in a fourth direction 264 parallel to the z-axis and opposite to the third direction 263. For example, the one or more second image sensors may be understood through the description of FIG. 2B.

FIG. 2B is a bottom view of an example electronic device in a first state.

Referring to FIG. 2B, in the first state, one or more second image sensors 250-2 disposed in a second housing part 220 may be located within a structure disposed in a first housing part 210 for the one or more second image sensors 250-2. For example, light from the outside of an electronic device 101 may be received by the one or more second image sensors 250-2 through the structure in the first state. For example, since the one or more second image sensors 250-2 are located within the structure in the first state, the one or more second image sensors 250-2 may be exposed through the structure in the first state. For example, the structure may be implemented in various ways. For example, the structure may be an opening or a notch. For example, the structure may be an opening 212a in a plate 212 of the first housing part 210 surrounding at least a part of the second housing part 220. However, it is not limited thereto. For example, in the first state, the one or more second image sensors 250-2 included in the second housing part 220 may be covered by at least a part of the plate 212 of the first housing part 210.

According to an embodiment, the first state may be changed to the second state.

For example, the first state (or the second state) may be changed to the second state (or the first state) through one or more intermediate states between the first state and the second state.

For example, the first state (or the second state) may be changed to the second state (or the first state) based on a predefined user input. For example, the first state (or the second state) may be changed to the second state (or the first state) in response to a user input for a physical button exposed through a part of the first housing part 210 or a part of the second housing part 220. For example, the first state (or the second state) may be changed to the second state (or the first state) in response to a touch input for an executable object displayed in the display area. For example, the first state (or the second state) may be changed to the second state (or the first state) in response to a touch input having a contact point on the display area and having a pressing intensity greater than or equal to a reference intensity. For example, the first state (or the second state) may be changed to the second state (or the first state) in response to a voice input received through a microphone of the electronic device 101. For example, the first state (or the second state) may be changed to the second state (or the first state) in response to an external force applied to the first housing part 210 and/or the second housing part 220 to move the second housing part 220 relative to the first housing part 210. For example, the first state (or the second state) may be changed to the second state (or the first state) in response to a user input identified by an external electronic device (e.g., earbuds or smart watch) connected to the electronic device 101. However, it is not limited thereto.

The second state may be understood through the description of FIGS. 2C and 2D.

FIG. 2C is a top plan view of an example electronic device in a second state.

Referring to FIG. 2C, an electronic device 101 may be in the second state. For example, in the second state, a second housing part 220 may be movable relative to a first housing part 210 in a second direction 262. For example, in the second state, volume of the electronic device 101 may be reduced as the second housing part 220 of a housing moves in the second direction 262. For example, in the second state, the second housing part 220 may not be moved in the first direction 261 relative to the first housing part 210.

According to an embodiment, in the second state, a display 230 may provide the display area having the largest size. For example, in the second state, the display area may correspond to an area 230c including an area 230a and an area 230b. For example, the area 230b that was included in the first housing part 210 in the first state may be exposed in the second state. According to an embodiment, as the second housing part 220 moves in the first direction 261 in the first state, at least a partial area of the display 230 (e.g., the area 230b) may be exposed to the outside for a user to view. For example, in the second state, the area 230a may include a planar portion. However, it is not limited thereto. For example, the area 230a may include a curved portion extending from the planar portion and located in an edge portion. According to an embodiment, in the second state, the area 230b may include the planar portion, unlike the area 230a in the first state. However, it is not limited thereto. For example, the area 230b may include a curved portion extending from the planar portion of the area 230b and located in the edge portion.

According to an embodiment, the second state may be referred to as a slide-out state or an open state in terms of that at least a part of the second housing part 220 is located outside the first housing part 210. For example, the second state may be referred to as an extended state in terms of providing the display area having the largest size. However, it is not limited thereto.

In an embodiment, a first image sensor 250-1 facing a third direction 263 (e.g., a rear direction of the electronic device 101) may be moved together with the area 230a, according to a movement of the second housing part 220 in the first direction 261, when a state of the electronic device 101 changes from the first state to the second state. For example, one or more second image sensors 250-2 facing a fourth direction 264 (e.g., a front direction of the electronic device 101) may be moved according to the movement of the second housing part 220 in the first direction 261, when the state of the electronic device 101 changes from the first state to the second state. For example, a relative positional relationship between the one or more second image sensors 250-2 and the structure exemplified through the description of FIG. 2B may be changed according to the movement of the one or more second image sensors 250-2. For example, the change in the relative positional relationship may be understood based on FIG. 2D.

FIG. 2D is a bottom view of an example electronic device in a second state.

Referring to FIG. 2D, in the second state, one or more second image sensors 250-2 may be located outside the structure. For example, in the second state, the one or more second image sensors 250-2 may be located outside an opening 212a in a plate 212. For example, since the one or more second image sensors 250-2 are located outside the opening 212a in the second state, the one or more second image sensors 250-2 may be exposed in the second state. For example, since the one or more second image sensors 250-2 are located outside the structure in the second state, the relative positional relationship in the second state may be different from the relative positional relationship in the first state.

In an embodiment, in case that the electronic device 101 does not include the structure, such as the opening 212a, the one or more second image sensors 250-2 in the second state may be exposed, unlike the one or more second image sensors 250-2 in the first state. For example, in the first state, the one or more second image sensors 250-2 are not exposed through the plate 212 because there is no opening 212a, but may be covered by a first housing part 210 and/or may be covered by the plate 212.

According to embodiments, the electronic device 101 may be in an intermediate state between the first state and the second state. According to an embodiment, a size of the display area in the intermediate state may be larger than a size of the display area in the first state and smaller than a size of the display area in the second state. According to an embodiment, the display area in the intermediate state may correspond to an area including an area 230a and a part of the area 230b. For example, in the intermediate state, a part of the area 230b may be exposed, and another part (or remaining part) of the area 230b may be covered by the first housing part 210 or may be rolled into the first housing part 210. However, embodiments are not limited thereto. According to an embodiment, as a second housing part 220 moves in a first direction 261, the size of the display area in the intermediate state may gradually increase. According to an embodiment, as the second housing part 220 moves in a second direction 262, the size of the display area in the intermediate state may gradually decrease.

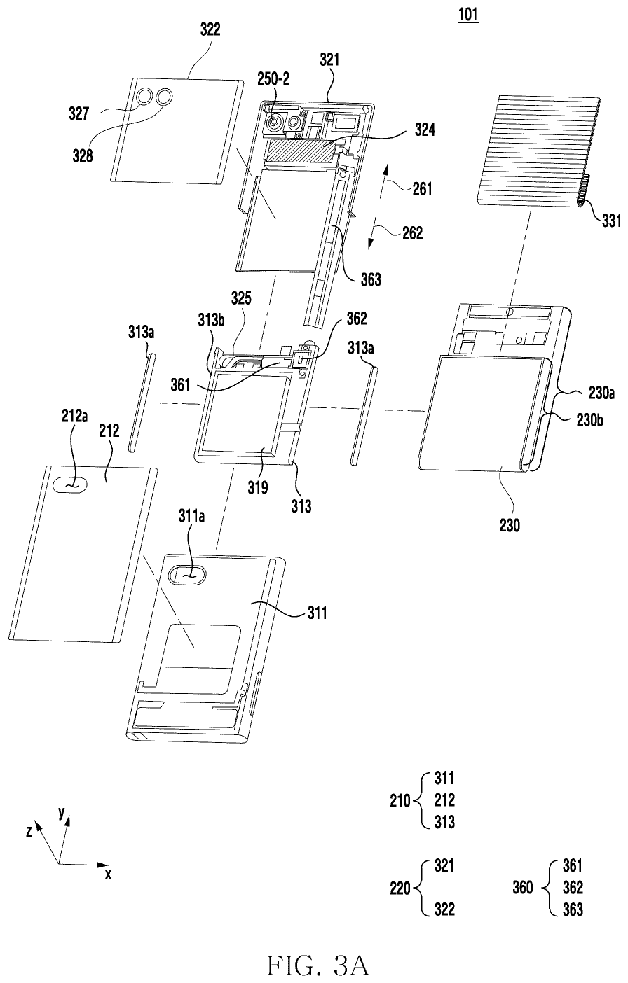

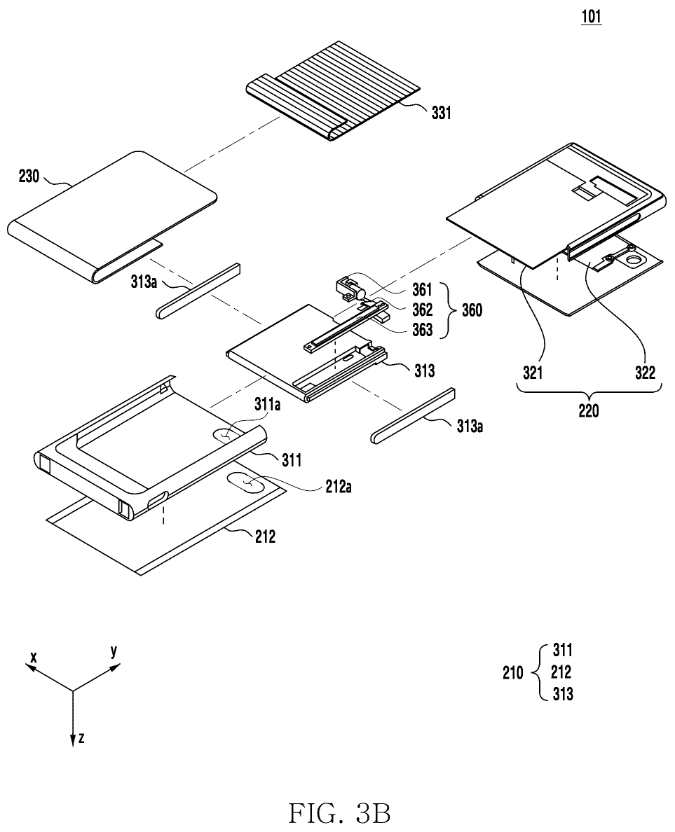

Referring back to FIG. 1, the electronic device 101 may include structures for moving a second housing (e.g., the second housing part 220 of FIG. 2C) of the electronic device 101 relative to a first housing (e.g., the first housing part 210 of FIG. 2C) of the electronic device 101. For example, the structures may be understood through the description of FIGS. 3A and 3B.

FIG. 3A is an exploded perspective view of an example electronic device. FIG. 3B is an exploded perspective view of an example electronic device.

Referring to FIGS. 3A and 3B, an electronic device 101 may include a first housing part 210, a second housing part 220, a display 230, and a driving unit 360.

According to an embodiment, the first housing part 210 may include a book cover 311, a plate 212, and a frame cover 313.

According to an embodiment, the book cover 311 may at least partially form a side surface portion of an outer surface of the electronic device 101. For example, the book cover 311 may at least partially form a rear surface portion of the outer surface. For example, the book cover 311 may include at least one opening 311a for one or more second image sensors 250-2. For example, the book cover 311 may include a surface supporting the plate 212. For example, the book cover 311 may be coupled with the plate 212. For example, the book cover 311 may include the frame cover 313. For example, the book cover 311 may be coupled with the frame cover 313.

According to an embodiment, the plate 212 may at least partially form the rear surface portion of the outer surface. For example, the plate 212 may include at least one opening 212a for the one or more second image sensors 250-2. For example, the plate 212 may be disposed on the surface of the book cover 311. For example, the opening 212a may be aligned with the opening 311a.

According to an embodiment, the frame cover 313 may be at least partially surrounded by the book cover 311.

According to an embodiment, the frame cover 313 may be at least partially surrounded by the display 230. For example, the frame cover 313 is at least partially surrounded by the display 230, but a position of the frame cover 313 may be maintained independently of a movement of the display 230. For example, the frame cover 313 may be arranged in relation to at least some of components of the display 230. For example, the frame cover 313 may include rails 313a that provide (or guide) a path for movement of at least one component of the display 230.

According to an embodiment, the frame cover 313 may be coupled with at least one component of the electronic device 101. For example, the frame cover 313 may support a rechargeable battery (e.g., a battery 319). For example, the battery 319 may be supported through a recess or a hole in a surface 313b of the frame cover 313. For example, the frame cover 313 may be coupled with one end of a flexible printed circuit board (FPCB) 325 on the surface of the frame cover 313. According to an embodiment, another end of the FPCB 325 may be connected to a PCB 324 through at least one connector. For example, the PCB 324 may be electrically connected to another PCB that supplies power to a motor 361 through the FPCB 325.

According to an embodiment, the frame cover 313 may be coupled with at least one structure of the electronic device 101 for a plurality of states including the first state and the second state. For example, the frame cover 313 may fasten the motor 361 of the driving unit 360.

According to an embodiment, the second housing part 220 may include a front cover 321 and a slide cover 322.

According to an embodiment, the front cover 321 may be at least partially surrounded by the display 230. For example, the front cover 321 may be coupled with at least a part of an area 230a of the display 230 surrounding the front cover 321, unlike the frame cover 313, so that the display 230 is moved along the second housing part 220 that is moved relative to the first housing part 210.

According to an embodiment, the front cover 321 may be coupled with at least one component of the electronic device 101. For example, the front cover 321 may be coupled with the printed circuit board (PCB) 324 including components of the electronic device 101. For example, the PCB 324 may include a processor 120 (see FIG. 1). For example, the front cover 321 may include the one or more second image sensors 250-2.

According to an embodiment, the front cover 321 may be coupled with at least one structure of the electronic device 101 for the plurality of states including the first state and the second state. For example, the front cover 321 may fasten a rack gear 363 of the driving unit 360.

According to an embodiment, the front cover 321 may be coupled with the slide cover 322.

According to an embodiment, the slide cover 322 may be coupled with the front cover 321 in order to protect at least one component of the electronic device 101 coupled within the front cover 321 and/or at least one structure of the electronic device 101 coupled within the front cover 321. For example, the slide cover 322 may include a structure for the at least one component. For example, the slide cover 322 may include one or more openings 328 for the one or more second image sensors 250-2. For example, the one or more openings 328 may be aligned with the one or more second image sensors 250-2 disposed on the front cover 321. For example, a size of each of the one or more openings 328 may correspond to a size of each of the one or more second image sensors 250-2.

According to an embodiment, the display 230 may include a support member 331. For example, the support member 331 may include a plurality of bars. For example, the plurality of bars may be coupled with each other.

According to an embodiment, the driving unit 360 may include the motor 361, a pinion gear 362, and the rack gear 363.

According to an embodiment, the motor 361 may operate based on power from the battery 319. For example, the power may be provided to the motor 361 in response to the predefined user input.

According to an embodiment, the pinion gear 362 may be coupled with the motor 361 through a shaft. For example, the pinion gear 362 may be rotated based on the operation of the motor 361 transmitted through the shaft.

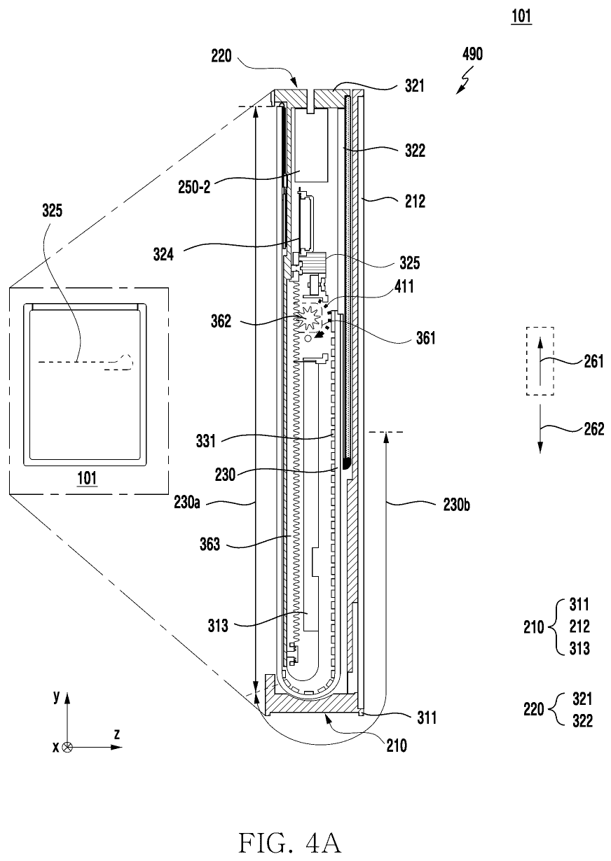

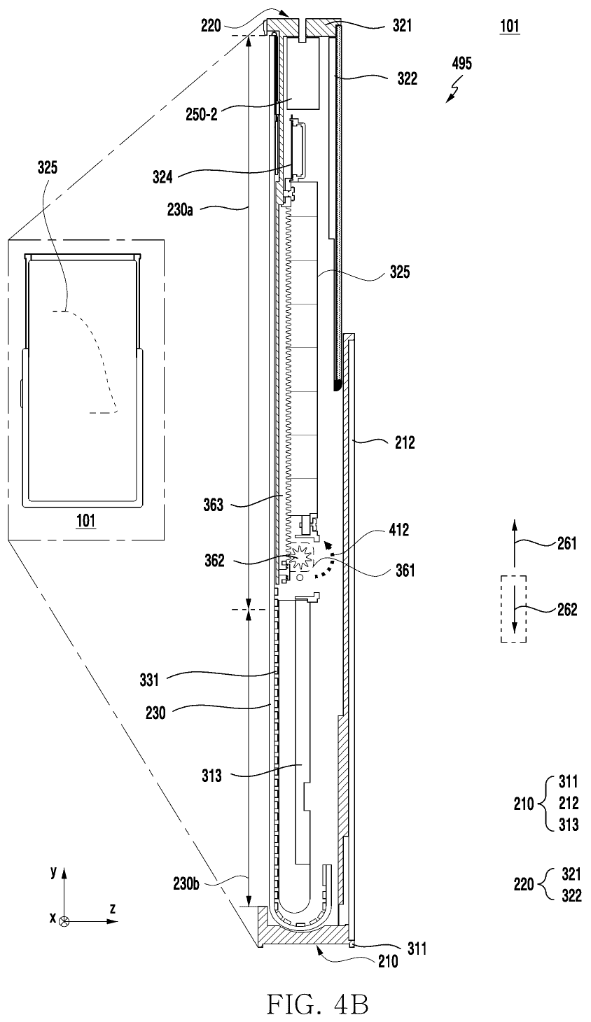

According to an embodiment, the rack gear 363 may be arranged in relation with the pinion gear 362. For example, teeth of the rack gear 363 may engage with teeth of the pinion gear 362. For example, according to the rotation of the pinion gear 362, the rack gear 363 may be moved in a first direction 261 or a second direction 262. For example, the second housing part 220 may be moved in the first direction 261 and the second direction 262 by the rack gear 363 that is moved according to the rotation of the pinion gear 362 due to the operation of the motor 361. For example, the first state of the electronic device 101 may be changed to a state (e.g., the one or more intermediate states or the second state) different from the first state through the movement of the second housing part 220 in the first direction 261. For example, the second state of the electronic device 101 may be changed to a state (e.g., the one or more intermediate states or the first state) different from the second state through the movement of the second housing part 220 in the second direction 262. For example, a change of the first state to the second state by the driving unit 360 and a change of the second state to the first state by the driving unit 360 may be understood through FIGS. 4A and 4B.

FIG. 4A is a cross-sectional view of an example electronic device in a first state. FIG. 4B is a cross-sectional view of an electronic device in a second state.

Referring to FIGS. 4A and 4B, a motor 361 may be operated based at least in part on the predefined user input received in a first state 490. For example, a pinion gear 362 may be rotated in a first rotation direction 411 based at least in part on the above operation of the motor 361. For example, a rack gear 363 may be moved in a first direction 261 based at least in part on the rotation of the pinion gear 362 in the first rotation direction 411. For example, since a front cover 321 in a second housing part 220 fastens the rack gear 363, the second housing part 220 may be moved in the first direction 261 based at least in part on the movement of the rack gear 363 in the first direction 261. For example, since the front cover 321 in the second housing part 220 is coupled with at least a part of an area 230a of a display 230 and fastens the rack gear 363, the display 230 may be moved based at least in part on the movement of the rack gear 363 in the first direction 261. For example, the display 230 may be moved along rails 313a. For example, a shape of at least some of the plurality of bars of a support member 331 of the display 230 may be changed when a first state 490 changes to a second state 495.

In an embodiment, an area 230b of the display 230 may be moved according to the movement of the display 230. For example, when the first state 490 is changed to the second state 495 according to the predefined user input, the area 230b may be moved through a space between a book cover 311 and a frame cover 313. For example, the area 230b in the second state 495 may be exposed, unlike the area 230b rolled into the space in the first state 490.

In an embodiment, since the front cover 321 in the second housing part 220 is coupled with a PCB 324 connected to the other end of a FPCB 325 and fastens the rack gear 363, a shape of the FPCB 325 may be changed when a state of the electronic device is changed from the first state 490 to the second state 495.

The motor 361 may be operated based at least in part on the predefined user input received in the second state 495. For example, the pinion gear 362 may be rotated in a second rotation direction 412 based at least in part on the above operation of the motor 361. For example, the rack gear 363 may be moved in a second direction 262 based at least in part on the rotation of the pinion gear 362 in the second rotation direction 412. For example, since the front cover 321 in the second housing part 220 fastens the rack gear 363, the second housing part 220 may be moved in the second direction 262 based at least in part on the movement of the rack gear 363 in the second direction 262. For example, since the front cover 321 in the second housing part 220 is coupled with at least a part of the area 230a of the display 230 and fastens the rack gear 363, the display 230 may be moved based at least in part on the movement of the rack gear 363 in the second direction 262. For example, the display 230 may be moved along the rails 313a. For example, the shape of at least some of the plurality of bars of the support member 331 of the display 230 may be changed when the second state 495 is changed to the first state 490. For example, as the second housing part 220 moves in the second direction 262 in the second state 495, the plurality of bars of the support member 331 may be changed in position, shape, or spacing, in order for them to be bent or support the bending, according to the bending in at least a partial area of the display 230.

According to an embodiment, the area 230b of the display 230 may be moved according to the movement of the display 230. For example, when the second state 495 is changed to the first state 490 according to the predefined user input, the area 230b may be moved through the space between the book cover 311 and the frame cover 313. For example, the area 230b in the first state 490 may be rolled into the space, unlike the area 230b exposed in the second state 495.

According to an embodiment, since the front cover 321 in the second housing part 220 is coupled with the PCB 324 connected to the other end of the FPCB 325 and fastens the rack gear 363, the shape of the FPCB 325 may be changed when the second state 495 is changed to the first state 490.

FIGS. 2A to 4B illustrate an electronic device 101 in which a height of the display area is changed and a width of the display area is maintained when the first state (or the second state) is changed to the second state (or the first state) in a portrait mode, but this is for convenience of description. For example, the electronic device 101 may be implemented as maintaining the height of the display area and changing the width of the display area, when the first state (or the second state) is changed to the second state (or the first state) in the portrait mode.

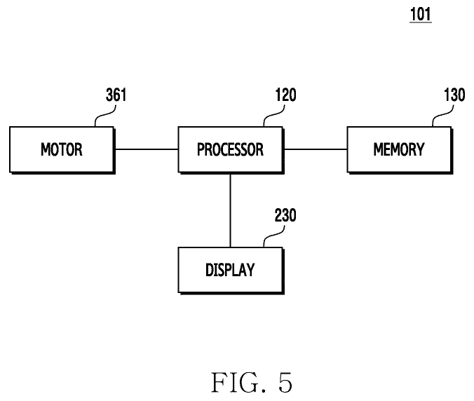

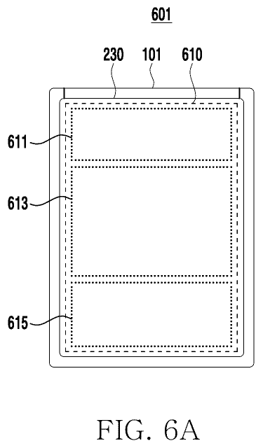

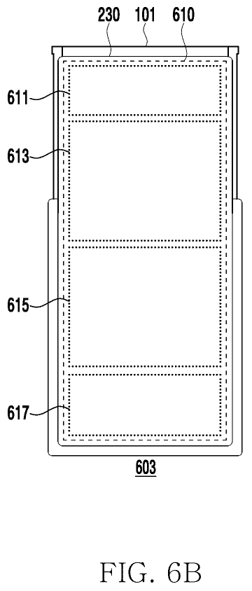

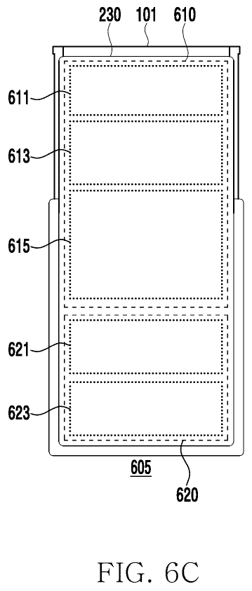

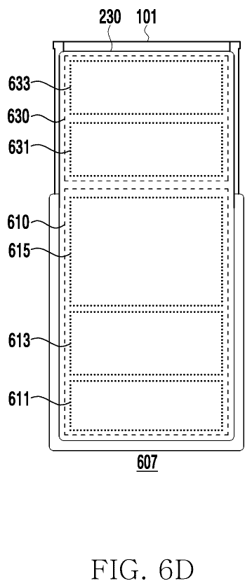

FIG. 5 is a schematic block diagram of an electronic device. FIG. 6A is a diagram illustrating an example of a layout of a user interface (UI) displayed in a reduced state of an electronic device according to an embodiment. FIG. 6B is a diagram illustrating an example of a layout of a UI displayed in an extended state of an electronic device according to an embodiment. FIG. 6C is a diagram illustrating an example of a layout of a UI displayed in an extended state of an electronic device according to an embodiment. FIG. 6D is a diagram illustrating an example of a layout of a UI displayed in an extended state of an electronic device according to an embodiment.

For the description of FIGS. 5, 6A, 6B, 6C, and 6D, components of an electronic device 101 described with reference to FIGS. 1, 2A, 2B, 2C, 2D, 3A, 3B, 4A, and 4B, and a structure of the electronic device 101 may be referenced.

Referring to FIG. 5, the electronic device 101 may include a processor 120, a memory 130, a display 230, and a motor 361.

In an embodiment, the processor 120 may display a screen including at least one object through the display 230. In an embodiment, the screen may include one or more areas. In an embodiment, at least one object may be included in each of the one or more areas. In an embodiment, each of the one or more areas may be referred to as a view group or a window. In an embodiment, the at least one object may include a UI element and/or content. In an embodiment, the at least one object may be referred to as a view or a frame. In an embodiment, the UI element may be an object (e.g., a check box, a button, an icon, a slider, a text field, a state bar, and a navigation bar) that may interact with a user. In an embodiment, the content may include text, an image, and/or a video.

In an embodiment, the processor 120 may display a screen in a display area (e.g., an area 230a of FIG. 2A) of the display 230 in a first state (or a slide-in state).

Referring to an example 601 of FIG. 6A, in the first state (or the slide-in state) of the electronic device 101, a screen 610 including one or more areas (e.g., the area 611, the area 613, and the area 615) may be displayed on the display 230. A screen including one or more areas may be referred to as a window (or layer) (or view group) (or (or view) container) distinguishable by at least one from among designated coordinates, size information, a separator, and a tag. In FIG. 6A, the one or more areas (e.g., the area 611, the area 613, and the area 615) in the screen 610 are exemplified as being arranged in a vertical direction, but this is only an example. In an embodiment, the one or more areas (e.g., the area 611, the area 613, and the area 615) in the screen 610 may be disposed according to various layouts (e.g., linear layout, relative layout, frame layout, constraint layout, grid layout, and table layout). In an embodiment, at least one content may be included in each of the one or more areas (e.g., the area 611, the area 613, and the area 615) in the screen 610. In an embodiment, the at least one content may include a visual object. In an embodiment, the visual object may include text, an image, and/or a video.

In an embodiment, a first housing part (e.g., a first housing part 210 of FIG. 2A) and a second housing part (e.g., a second housing part 220 of FIG. 2A) may be changed between the first state and a second state by the power of the motor 361. However, it is not limited thereto. For example, the first housing part 210 and the second housing part 220 may be changed between the first state and the second state by an external force (e.g., a force that the user pulls, or a force that the user pushes).

In an embodiment, a size of the display area of the display 230 may be changed by the change between the first state and the second state. In an embodiment, as the size of the display area of the display 230 is changed, the processor 120 may update a screen to be displayed on the display area of the display 230.

In an embodiment, the processor 120 may display a screen in the display area (e.g., area 230a, area 230b, or area 230c of FIG. 2C) of the display 230 in the second state (or a slide-out state).

In an embodiment, the processor 120 may display a screen in which one or more areas included in the screen in the first state are enlarged on the display area (the 230c of FIG. 2C) of the display 230 in the second state. In an embodiment, one or more areas in the second state may be enlarged from the one or more areas in the first state. In an embodiment, the one or more areas in the second state may be enlarged by a ratio between a screen area in the first state and a screen area in the second state. In an embodiment, at least one more content may be further displayed in the enlarged area in the second state, compared with the area in the first state. However, it is not limited thereto. In an embodiment, a size of at least one content included in the enlarged area in the second state may be enlarged (e.g., enlarged by the above ratio) such as to be larger than a size of the at least one content included in the area in the first state.

Referring to an example 603 of FIG. 6B, in the second state (or the slide-out state) of the electronic device 101, the screen 610 including one or more areas (e.g., the area 611, the area 613, the area 615, and the area 617) may be displayed on the display 230. At least one more area (e.g., the area 617) may be further displayed on the screen 610 of the example 603 of FIG. 6B, compared with the screen 610 of the example 601 of FIG. 6A. The screen 610 of the example 603 of FIG. 6B may be larger than the screen 610 of the example 601 of FIG. 6A.

In an embodiment, the processor 120 may display a screen including an additional area in the area in the first state on the display area (e.g., the area 230a and the area 230b of FIG. 2C) of the display 230 in the second state. In an embodiment, the additional area may be located above the areas in the first state. In an embodiment, the additional area may be located below the areas in the first state.

Referring to an example 605 of FIG. 6C, in the second state of the electronic device 101, on the display 230, the screen 610 including the one or more areas (e.g., the area 611, the area 613, and the area 615) and an additional screen 620 including one or more areas (e.g., an area 621 and the area 623) may be displayed. The additional screen 620 of the example 605 of FIG. 6C may be located below the one or more areas (e.g., the area 611, the area 613, and the area 615) of the screen 610. The screen 610 of the example 605 of FIG. 6C may have the same size as the screen 610 of the example 601 of FIG. 6A.

Referring to an example 607 of FIG. 6D, in the second state of the electronic device 101, on the display 230, the screen 610 including the one or more areas (e.g., the area 611, the area 613, and the area 615) and a screen 630 including one or more areas (e.g., an area 631 and an area 633) may be displayed. The screen of the example 607 of FIG. 6D may be located above the one or more areas (e.g., the area 611, the area 613, and the area 615) of the screen 610. The screen 610 of the example 607 of FIG. 6D may have the same size as the screen 610 of the example 601 of FIG. 6A.

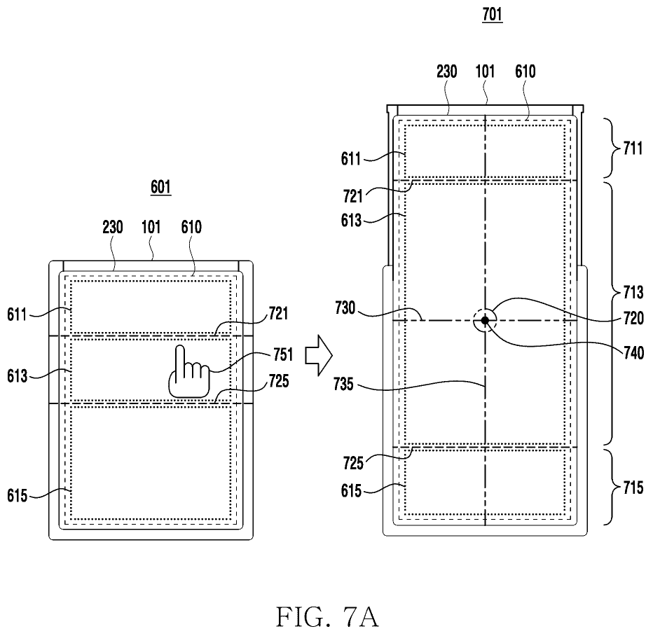

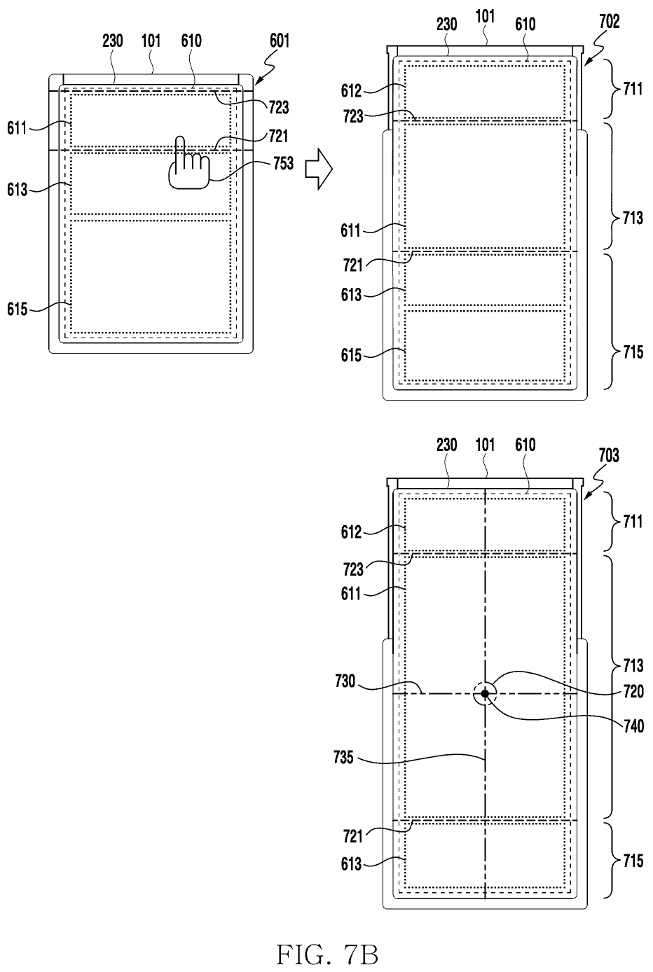

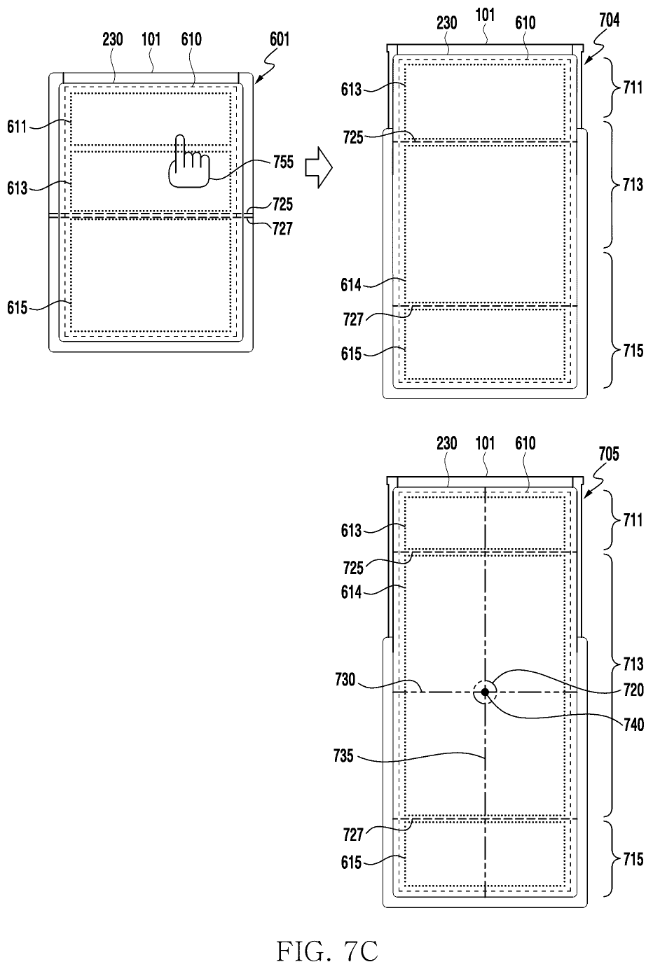

As described above, as the electronic device 101 is changed from the first state to the second state, in case that the size of one or more areas included in the screen is enlarged without a change of the layout, or the number of one or more areas included in the screen is changed, a screen different from the user's intention may be displayed in the second state. Thus, according to the user's intention, it may be required to provide a method for displaying a screen selected from among a screen generated without the change of the layout in the second state or a screen generated with the change of the layout. Hereinafter, an operation for the electronic device 101 to display the screen generated with the change of the layout will be described with reference to FIGS. 7 to 12.

FIG. 7A is a diagram illustrating an example of a layout of a UI displayed in an extended state of an electronic device according to an embodiment.

For the description of FIG. 7A, components of an electronic device 101 described with reference to FIGS. 1, 2A, 2B, 2C, 2D, 3A, 3B, 4A, 4B, 5, and 6A and a structure of the electronic device 101 may be referenced.

In an embodiment, referring to an example 601 of FIG. 7A, the electronic device 101 may obtain a user input 751 while displaying a screen 610 including one or more areas (e.g., the area 611, the area 613, and the area 615) in a display area (e.g., an area 230a of FIG. 2A), in a first state (or a slide-in state). In an embodiment, the user input 751 may include an input for selecting one content (e.g., content in the area 613) among the one or more areas (e.g., the area 611, the area 613, and the area 615) displayed in the first state. In an embodiment, the user input 751 may include an input for requesting a change from the first state to the second state. In an embodiment, the user input 751 may include an input for selecting one content (e.g., the content in the area 613) and requesting a change to the second state. FIG. 7A illustrates that a width of the areas (e.g., the area 611, the area 613, and the area 615) corresponds to a width of the area 230a of the display 230, but this is only an example. The width of the areas (e.g., the area 611, the area 613, and the area 615) may be shorter than the width of the area 230a of the display 230. In an embodiment, two or more areas (e.g., the area 611, the area 613, and the area 615) may be arranged in a width direction on the display 230.

In an embodiment, in response to the user input 751, the electronic device 101 may display the screen 610 in which the area 613 selected in the second state (or the slide-out state) is enlarged. In an embodiment, the selected area (e.g., the area 613) may be an area at a position where the user input 751 is obtained from among the two or more areas (e.g., the area 611, the area 613, and the area 615). In an embodiment, the selected area (e.g., the area 613) may be an area located in a designated area when the user input 751 is obtained from among the two or more areas (e.g., the area 611, the area 613, and the area 615). In an embodiment, the designated area may be an area located in the middle of a plurality of areas when two or more areas (e.g., the area 611, the area 613, and the area 615) are displayed in a display area with a first size. In an embodiment, the plurality of areas may be areas arranged along a direction (e.g., a second direction 262 of FIG. 2A) in which the display area of the display 230 is extended.

In an embodiment, the selected area (e.g., the area 613) may be enlarged according to a ratio (or aspect ratio) of the selected area (e.g., the area 613). In an embodiment, the selected area (e.g., the area 613) may be enlarged according to a ratio (or aspect ratio) of content included in the selected area (e.g., the area 613). In an embodiment, the selected area (e.g., the area 613) may be enlarged according to a ratio (or aspect ratio) of one visual object (e.g., an image, or a video) included in the selected area (e.g., the area 613). In an embodiment, the ratio (or aspect ratio) of the selected area (e.g., the area 613) may be a ratio (or aspect ratio) designated by an application 146 (or middleware 144) that generates a screen on which the selected area (e.g., the area 613) is displayed. Here, according to the ratio of the selected area (e.g., the area 613), enlarging the selected area (e.g., the area 613) may mean enlarging to a maximum size that does not deviate from a display area (e.g., an area 230c of FIG. 2C) in the second state. For example, in case that a length of the display 230 in a height direction is longer than a length in the width direction, and a horizontal length of the selected area (e.g., the area 613) is longer than a vertical length, as the enlarged area (e.g., the area 613) is displayed on the area 230c in the second state, areas (e.g., the area 711 and the area 715) corresponding to a letter box may be generated above and/or below an area 713 in which the enlarged area (e.g., the area 613) is displayed in the area 230c. For example, in case that the length of the display 230 in the height direction is longer than the length in the width direction, and the vertical length of the selected area (e.g., the area 613) is longer than the horizontal length, as the enlarged area (e.g., the area 613) is displayed on the area 230c in the second state, areas corresponding to a filler box may be generated on the left side and/or right side of the area 713 in which the enlarged area (e.g., the area 613) is displayed in the area 230c. In an embodiment, in the letter box and/or the filler box, unselected areas (e.g., the area 611 and the area 615) among one or more areas (e.g., the area 611, the area 613 and the area 615) displayed in the first state may be displayed. In an embodiment, in the letter box and/or the filler box, contents that are not displayed in the first state may be displayed.

In an embodiment, the electronic device 101 may enlarge the selected area (e.g., the area 613) by enlarging the boundary of the selected area (e.g., the area 613) while changing from the first state to the second state. In an embodiment, enlarging the boundary of the selected area (e.g., the area 613) may include moving at least one side among sides (e.g., the side 721 and the side 725) of the selected area (e.g., the area 613). In an embodiment, the sides (e.g., the side 721 and the side 725) of the selected area (e.g., the area 613) may be a side of a frame in which the selected area (e.g., the area 613) is disposed. In an embodiment, the sides (e.g., the side 721 and the side 725) may be sides surrounding the frame in which the selected area (e.g., the area 613) is disposed. In an embodiment, the sides (e.g., the side 721 and the side 725) may be a side perpendicular to the direction (e.g., the second direction 262 of FIG. 2A) in which the display area of the display 230 is extended. For example, in case that a height of the display area of the display 230 is changed while changing from the first state to the second state, the sides (e.g., the side 721 and the side 725) may be sides extending in the width direction. However, it is not limited thereto. For example, in case that a width of the display area of the display 230 is changed while changing from the first state to the second state, the sides (e.g., the side 721 and the side 725) may be sides extending in the height direction. In an embodiment, the sides (e.g., the side 721 and the side 725) of the selected area (e.g., the area 613) may be a side of the frame in which the selected area (e.g., the area 613) is disposed.

In an embodiment, referring to an example 701 of FIG. 7A, the electronic device 101 may display the screen 610 arranged based on the selected area (e.g., the area 613) in the second state in response to the user input 751. In an embodiment, that the screen 701 is arranged based on the selected area (e.g., the area 613) may mean that the area 613 displayed in the second state is displayed between other contents. In an embodiment, displaying the selected area (e.g., the area 613) between other areas may mean that other contents are displayed in the letter box and/or the filler box generated as the selected area (e.g., the area 613) is enlarged.

In an embodiment, that the screen 701 is arranged based on the selected area (e.g., the area 613) may mean that the area 613 displayed in the second state is located at a center position 740 of the display area (e.g., the area 230c of FIG. 2C). In an embodiment, that the screen 701 is arranged based on the selected area (e.g., the area 613) may mean that a center area 720 of the area 613 displayed in the second state includes the center position 740 of the area 230c. In an embodiment, the center position 740 of the area 230c in the second state may include a center position of a long axis 735 of the area 230c. In an embodiment, the center position 740 of the area 230c in the second state may include a center position of a short axis 730 of the area 230c. In an embodiment, the center position 740 of the area 230c in the second state may include a point where the center position of the long axis 735 of the area 230c meets the center position of the short axis 730 of the area 230c. In an embodiment, the area 613 displayed in the second state may have a larger size than a size of the area 613 displayed in the first state.

In an embodiment, the electronic device 101 may move the selected area (e.g., the area 613) to display the selected area (e.g., the area 613) between other contents while changing from the first state to the second state. In an embodiment, while changing from the first state to the second state, the electronic device 101 may move the selected area (e.g., the area 613) based on the direction (e.g., the second direction 262 of FIG. 2A) in which the display area of the display 230 is extended. In an embodiment, in case that the height of the display area of the display 230 is changed while changing from the first state to the second state, the electronic device 101 may move the selected area (e.g., the area 613) in the height direction (e.g., the first direction 261 of FIG. 2A) or an opposite direction (e.g., the second direction 262 of FIG. 2A) of the height direction. However, it is not limited thereto. For example, in case that the width of the display area of the display 230 is changed while changing from the first state to the second state, the electronic device 101 may move the selected area (e.g., the area 613) in the width direction or an opposite direction of the width direction.

In an embodiment, the electronic device 101 may move the selected area (e.g., the area 613) in a moving direction of the area 613 determined based on a positional relationship between the selected area (e.g., the area 613) and the center position 740 of the area 230c. For example, in case that the selected area (e.g., the area 613) is located above the center position 740 of the area 230c, the electronic device 101 may move the area 613 in the second direction 262 while changing from the first state to the second state. For example, in case that the selected area (e.g., the area 613) is located below the center position 740 of the area 230c, the electronic device 101 may move the selected area (e.g., the area 613) in the first direction 261 while changing from the first state to the second state. However, it is not limited thereto. For example, in case that the width of the display area of the display 230 is changed while changing from the first state to the second state, the electronic device 101 may move the selected area (e.g., the area 613) in a moving direction of the area 613 determined by whether the selected area (e.g., the area 613) is located on the left side or right side of the center position 740 of the area 230c.

In an embodiment, a movement of the selected area (e.g., the area 613) may include changing a display position of the area 613 while maintaining a size of the area 613. In an embodiment, the movement of the selected area (e.g., the area 613) may include changing the display position of the area 613 while enlarging the size of the area 613. In an embodiment, changing the display position of the selected area (e.g., the area 613) may mean that an area occupied by the area 613 is changed within the area 230a or the area 230c of the display 230.

In an embodiment, the electronic device 101 may display a partial area (e.g., the area 611 located above the selected area (e.g., the area 613)) among the areas (e.g., the area 611 and the area 615) that is not selected in the first state, around the area 613 in the second state. In an embodiment, a periphery of the area 613 may be an area of the letter box and/or the filler box.

In an embodiment, the electronic device 101 may display the partial area (e.g., the area 611 located above the selected area (e.g., the area 613)) among the areas (e.g., the area 611 and the area 615) that is not selected in the first state, above the area 613 in the second state. In an embodiment, the electronic device 101 may display the partial area (e.g., the area 611 located above the selected area (e.g., the area 613)) among the at least one area (e.g., the area 611) displayed above the selected area (e.g., the area 613) in the first state, above the area 613 in the second state. In an embodiment, the partial area (e.g., the area 611 located above the selected area (e.g., the area 613)) displayed above the area 613 in the second state may be content displayed directly above the area 613 in the first state. In an embodiment, some content (e.g., content within the area 611 located above the selected area (e.g., the area 613)) displayed above the area 613 in the second state may be a designated type of content among contents displayed above the area 613 in the first state. In an embodiment, the designated type of content may be a different type of content from the content included in the area 613. In an embodiment, the designated type of content may be content related to a profile. In an embodiment, a size of the partial area (e.g., the area 611) displayed in the second state may be changed according to a size of the selected area (e.g., the area 613) in the second state. For example, the size of the partial area (e.g., the area 611 located above the selected area (e.g., the area 613)) displayed in the second state may become smaller than the size in the first state. In an embodiment, the area 611 displayed in the second state may include some of the content included in the area 611 displayed in the first state. However, it is not limited thereto. For example, the size of the partial area (e.g., the area 611 located above the selected area (e.g., the area 613)) displayed in the second state may become equal to or larger than the size in the first state.

In an embodiment, the electronic device 101 may display a partial area (e.g., the area 615 located below the selected area (e.g., the area 613)) among the areas (e.g., the area 611 and the area 615) that are not selected in the first state, below the area 613 in the second state. In an embodiment, the electronic device 101 may display the partial area (e.g., the area 615 located below the selected area (e.g., the area 613)) among the at least one area (e.g., the area 615) displayed below the selected area (e.g., the area 613) in the first state, below the area 613 in the second state. In an embodiment, the partial area (e.g., the area 615) displayed below the area 613 in the second state may be content displayed directly below the area 613 in the first state. In an embodiment, the partial area (e.g., the area 615 located below the selected area (e.g., the area 613)) displayed below the area 613 in the second state may be a designated type of content among contents displayed below the area 613 in the first state. For example, a size of the partial area (e.g., the area 615 located below the selected area (e.g., the area 613)) displayed in the second state may become smaller than a size in the first state. In an embodiment, the area 615 displayed in the second state may include some of the content included in the area 615 displayed in the first state. However, it is not limited thereto. For example, the size of the partial area (e.g., the area 615 located below the selected area (e.g., the area 613)) displayed in the second state may become equal to or larger than the size in the first state.

In an embodiment, the electronic device 101 may not display another partial area among the areas (e.g., the area 611 and the area 615) that are not selected in the first state, in the second state. In an embodiment, the electronic device 101 may display at least one area that is not displayed in the first state, around the area 613 in the second state. In an embodiment, the periphery of the area 613 may be the area of the letter box and/or the filler box.

In an embodiment, the electronic device 101 may display an area that is not displayed in the first state on at least one area (e.g., the area 230c) in the second state, in response to the user input 751. In an embodiment, the electronic device 101 may display the area that is not displayed in the first state on the area 230c in the second state, according to the size of the selected area (e.g., the area 613) displayed in the area 230c. For example, as the first state is changed to the second state, in case that the area 613 is moved upward, at least one area may be further displayed below the area 613 in the second state. For example, as the first state is changed to the second state, in case that the area of the selected area (e.g., the area 613) is moved downward, at least one area in the second state may be further displayed above the area 613.

As described above, the electronic device 101 may display the area 613 selected from among the displayed areas (e.g., the area 611, the area 613, and the area 615) at a designated position of the enlarged display area, based on a user's request for enlargement of the display area of the display 230. The electronic device 101 may provide a user-friendly layout by displaying the selected area (e.g., the area 613) at the designated position of the enlarged display area. Accordingly, additional user efforts for enlarging and/or moving position of content suitable for the user may not be required.

FIG. 7B is a diagram illustrating an example of a layout of a UI displayed in an extended state of an electronic device according to an embodiment.

For the description of FIG. 7B, components of an electronic device 101 described with reference to FIGS. 1, 2A, 2B, 2C, 2D, 3A, 3B, 4A, 4B, 5, and 6A and a structure of the electronic device 101 may be referenced. Contents described with reference to FIG. 7A may not be repeated in the description of FIG. 7B.

Compared to FIG. 7A, FIG. 7B illustrates an example of a layout of a UI displayed as a user selects an area located outside a display area of a display 230. In an embodiment, that the area is located outside the display area may mean that at least one side of the area contacts a side perpendicular to a direction (e.g., a second direction 262 of FIG. 2A) in which the display area is extended.

In an embodiment, referring to an example 601 of FIG. 7B, the electronic device 101 may obtain a user input 753 while displaying a screen 601 including a screen 610 including one or more areas (e.g., the area 611, the area 613, and the area 615) in a display area (e.g., an area 230a of FIG. 2A) in a first state (or a slide-in state).

In an embodiment, referring to an example 703 of FIG. 7B, the electronic device 101 may display the screen 610 in which the area 611 selected in a second state (or a slide-out state) is enlarged, in response to the user input 753.

In an embodiment, the electronic device 101 may enlarge the selected area (e.g., the area 611) by moving at least one side among sides (e.g., the side 721 and the side 723) of the selected area (e.g., the area 611) while changing from the first state to the second state. In an embodiment, enlarging the boundary of the area 611 may include moving at least one side among the sides (e.g., the side 721 and the side 723) of the selected area (e.g., the area 611).

In an embodiment, referring to an example 703 of FIG. 7B, the electronic device 101 may display the screen 610 arranged based on the selected area (e.g., the area 611) in the second state, in response to the user input 753. In an embodiment, that the selected screen (e.g., the screen 610) is arranged based on the selected area (e.g., the area 611) may mean that the area 611 displayed in the second state is displayed between other areas. In an embodiment, that the selected area (e.g., the area 611) is displayed between other areas may mean that other contents are displayed in a letter box and/or a filler box generated as the area 611 is enlarged.

In an embodiment, the electronic device 101 may move the area 611, in order to display the selected area (e.g., the area 611) between other contents, while changing from the first state to the second state. In an embodiment, while changing from the first state to the second state, the electronic device 101 may move the area 611 based on the direction (e.g., the second direction 262 of FIG. 2A) in which the display area of the display 230 is extended. As in an example 702 of FIG. 7B, the electronic device 101 may gradually move the selected area (e.g., the area 611) downward while changing from the first state to the second state. As the selected area (e.g., the area 611) is gradually moved downward, a new area 612 may be further displayed above the area 611. However, it is not limited thereto. For example, in case that the area 615 is selected by the user input 753, the electronic device 101 may gradually move the selected area (e.g., the area 615) upward while changing from the first state to the second state. As the area 615 is gradually moved upward, a new area may be further displayed below the area 615.

In an embodiment, referring to the example 702 of FIG. 7B, the electronic device 101 may display at least one content on the area 612 generated according to a movement of the area 611 located outside the display area while changing from the first state to the second state. In an embodiment, the area 612 may be generated by moving away from a side perpendicular to the direction (e.g., the second direction 262 of FIG. 2A) in which the display area in contact with at least one side of a frame of the content is extended, while changing from the first state to the second state.

In an embodiment, the electronic device 101 may display content that is not displayed in the first state on at least one area (e.g., the area 612) of the area 230c in second state, in response to the user input 753.

As described above, the electronic device 101 may display the area 611 selected from among the displayed areas (e.g., the area 611, the area 613, and the area 615) at a designated position of the enlarged display area based on a user's request for enlargement of the display area of the display 230. The electronic device 101 may allow the user to feel a smooth layout change, by gradually moving the selected area (e.g., the area 611) to the designated position. In addition, the electronic device 101 may not require additional user efforts for enlarging and/or moving position of content suitable for the user, by gradually moving the selected area (e.g., the area 611) to the designated position.

FIG. 7C is a diagram illustrating an example of a layout of a UI displayed in an extended state of an electronic device according to an embodiment.

For the description of FIG. 7C, components of an electronic device 101 described with reference to FIGS. 1, 2A, 2B, 2C, 2D, 3A, 3B, 4A, 4B, 5, and 6A and a structure of the electronic device 101 may be referenced. Contents described with reference to FIG. 7A or FIG. 7B may not be repeated in the description of FIG. 7C.

Compared to FIG. 7B, FIG. 7C illustrates an example of a layout of a UI arranged based on another area (e.g., the area 614) instead of an area 611 selected by a user in a display area of a display 230. In an embodiment, the other area (e.g., the area 614) may include content mapped to the area 611. In an embodiment, the other area (e.g., the area 614) may include content hyperlinked to the area 611. In an embodiment, the other area (e.g., the area 614) may include content obtained from an external device (e.g., a server 108, an electronic device 102, or an electrical device 103) by a user input 755 to the area 611.

In an embodiment, referring to an example 601 of FIG. 7C, the electronic device 101 may obtain the user input 755 while displaying a screen 610 including one or more areas (e.g., the area 611, the area 613, and the area 615) in a display area (e.g., an area 230a of FIG. 2A) in a first state (or a slide-in state).

In an embodiment, the electronic device 101 may identify content mapped to the area 611 in response to the user input 755. In an embodiment, the electronic device 101 may identify content hyperlinked to the area 611, in response to the user input 755. In an embodiment, the electronic device 101 may obtain content from an external device (e.g., a server 108, an electronic device 102, or an electronic device 103) in response to the user input 755 to the area 611.

In an embodiment, referring to an example 705 of FIG. 7C, the electronic device 101 may display the area 614 including content obtained in a second state (or a slide-out state) in response to the user input 755. In an embodiment, the area 614 may be the enlarged area according to a ratio of obtained content. In an embodiment, a ratio of the area 614 may be a ratio designated by an application 146 (or middleware 144) that generates a screen on which the area 614 is displayed.

In an embodiment, the electronic device 101 may enlarge the area 614 by moving at least one side among sides (e.g., the side 725 and the side 727) of the area 614 while changing from the first state to the second state. In an embodiment, enlarging the boundary of the area 614 may include moving at least one side among the sides (e.g., the side 725 and the side 727) of the area 614.

In an embodiment, referring to an example 705 of FIG. 7C, the electronic device 101 may display the screen 610 arranged based on the area 614 including the obtained content in the second state, in response to the user input 755. In an embodiment, that the screen 610 is arranged based on the area 614 may mean that the area 614 displayed in the second state is displayed between other areas. In an embodiment, that the area 614 is displayed between other areas may mean that areas where other contents are displayed are located in a letter box and/or a filler box generated as the area 614 is enlarged.

In an embodiment, that the screen 701 is arranged based on the area 614 including the obtained content may mean that the area 614 displayed in the second state is located at a center position 740 of a display area (e.g., an area 230c of FIG. 2C). In an embodiment, that the screen 701 is arranged based on the area 614 including the obtained content may mean that a center area 720 of the area 614 displayed in the second state includes the center position 740 of an area (e.g., an area 230c).

In an embodiment, the electronic device 101 may move the area 614 to display the area 614 between other areas while changing from the first state to the second state. In an embodiment, while changing from the first state to the second state, the electronic device 101 may move the area 614 based on a direction (e.g., a second direction 262 of FIG. 2A) in which the display area of the display 230 is extended. As in an example 704 of FIG. 7C, the electronic device 101 may gradually enlarge the area 614 between the area 613 and the area 615 while changing from the first state to the second state. While changing from the first state to the second state, the electronic device 101 may gradually enlarge the area 614 between two areas (e.g., the area 613 and the area 615) facing each other along the direction (e.g., the second direction 262 of FIG. 2A) in which the display area is extended.

In an embodiment, the electronic device 101 may display some areas (e.g., the areas (e.g., the area 613 and the area 615)) among the areas (e.g., the area 613 and the area 615) that are not selected in the first state, around the area 614 in the second state. In an embodiment, a periphery of the area 614 may be an area of the letter box and/or the filler box.

In an embodiment, the electronic device 101 may display a partial area (e.g., the area 613) among the areas (e.g., the area 613 and the area 615) that are not selected in the first state, above the area 614 in the second state. In an embodiment, the electronic device 101 may display the partial area (e.g., the area 613) displayed above the area 614 selected in the first state, above the area 614 in the second state. In an embodiment, the electronic device 101 may display a partial area (e.g., the area 615) among the areas (e.g., the area 613 and the area 615) that are not selected in the first state, below the area 614 in the second state. In an embodiment, the electronic device 101 may display the partial area (e.g., the area 615) displayed below the area 614 selected in the first state, below the area 614 in the second state.

As described above, the electronic device 101 may display content obtained by the area 611 selected from among the displayed areas (e.g., the area 611, the area 613, and the area 615) at a designated position of the enlarged display area, based on a user's request for enlargement of the display area of the display 230. The electronic device 101 may allow the user to feel a smooth layout change, by gradually enlarging the area 614 including the content obtained by the selected area (e.g., the area 611) between designated areas. In addition, the electronic device 101 may not require additional user efforts for enlarging and/or moving position of content suitable for the user, by gradually enlarging the area 614 between designated areas.

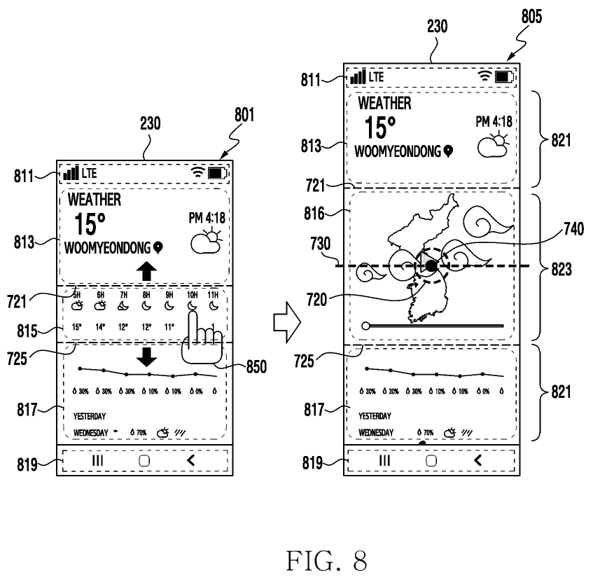

FIG. 8 is a diagram illustrating an example of a change in a layout of a UI according to a change from a reduced state to an extended state of an electronic device according to an embodiment.

For the description of FIG. 8, components of an electronic device 101 described with reference to FIGS. 1, 2A, 2B, 2C, 2D, 3A, 3B, 4A, 4B, FIG. 5, 6A, 7A, 7B, and 7C, and a structure of the electronic device 101 may be referenced.

In an embodiment, referring to an example 801 of FIG. 8, the electronic device 101 may obtain a user input 850 while displaying a screen including one or more areas (e.g., the area 811, the area 813, the area 815, the area 817, and the area 819) in a display area (e.g., an area 230a of FIG. 2A), in a first state (or a slide-in state). In an embodiment, in an area 811, a state bar may be displayed. In an embodiment, in the areas (e.g., the area 813, the area 815, and the area 817), a screen generated through one application may be displayed. In an embodiment, in the area 813, content that summarizes weather information may be displayed. In an embodiment, in the area 815, content including temperature information by hour may be displayed. In an embodiment, in the area 817, content including precipitation probability information by hour may be displayed. In an embodiment, in the area 819, a navigation bar may be displayed. In the screen 801 of FIG. 8, the state bar and the navigation bar are illustrated to be included, but this is only an example. According to an embodiment, in the first state, the screen displayed on the display area may not include the state bar and/or the navigation bar.

In an embodiment, the electronic device 101 may identify content mapped to the area 815, in response to the user input 850. In an embodiment, the electronic device 101 may identify content hyperlinked to the area 815, in response to the user input 850. In an embodiment, the electronic device 101 may obtain content from an external device (e.g., a server 108, or an electronic device 102 and 103), in response to the user input 850 to the area 815. In an embodiment, the content mapped to the area 815 may be content including radar meteorological information.

In an embodiment, referring to an example 805 of FIG. 8, the electronic device 101 may display an area 816 including content obtained in a second state (or a slide-out state), in response to the user input 850. According to an embodiment, the area 816 may be the enlarged area, according to a ratio of obtained content. In an embodiment, a ratio of the area 816 may be a ratio designated by an application 146 (or middleware 144) that generates a screen on which the area 816 is displayed.

In an embodiment, the electronic device 101 may enlarge the area 816, by moving at least one side among the sides (e.g., the side 721 and the side 725) of the area 816, while changing from the first state to the second state. In an embodiment, expanding the boundary of the area 816 may include moving at least one side among the sides (e.g., the side 721 and the side 725) of the area 816. For example, the electronic device 101 may enlarge upward the side 721 that is in contact with the upper area (e.g., the area 813) among the sides (e.g., the side 721 and the side 725) of the area 816, and may enlarge downward the side 725 that is in contact with the lower area (e.g., the area 817) among the sides (e.g., the side 721 and the side 725) of the area 816.

In an embodiment, referring to the example 805 of FIG. 8, the electronic device 101 may display the screen 810 arranged based on the area 816 including the obtained content in the second state, in response to the user input 850. In an embodiment, that the screen 810 is arranged based on the area 816 may mean that the area 816 displayed in the second state is displayed between other areas. In an embodiment, that the area 816 is displayed between the other areas may mean that areas where other contents are displayed are located in a letter box and/or a filler box generated as the area 816 is enlarged.

In an embodiment, referring to the example 805 of FIG. 8, the electronic device 101 may display the area 816 including obtained content in the area 815 in which the user input 850 is obtained, in response to the user input 850. While changing from the first state to the second state, the electronic device 101 may gradually enlarge the area 816 between the two areas (e.g., the area 813 and the area 817) facing each other along a direction (e.g., a second direction 262 of FIG. 2A) in which the display area is extended.

In an embodiment, in response to the user input 850, the electronic device 101 may gradually enlarge the area 815 in which the user input 850 is obtained between two areas (e.g., the area 813 and the area 817) facing each other, and then may display the area 816 instead of the area 815 in the second state. In an embodiment, the electronic device 101 may apply a designated graphic effect to the area 815 and/or the area 816 to display the area 816 instead of the area 815. For example, the electronic device 101 may apply a fade-out effect to the area 815, and may apply a fade-in effect to the area 816.

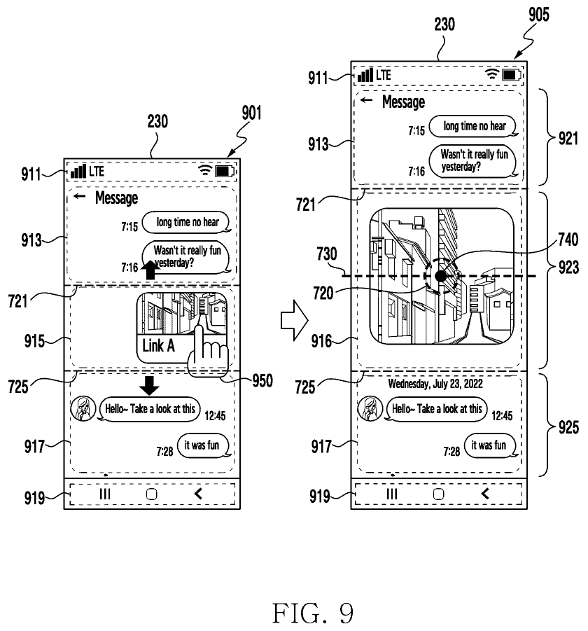

FIG. 9 is a diagram illustrating an example of a change in a layout of a UI according to a change from a reduced state to an extended state of an electronic device according to an embodiment.

For the description of FIG. 9, components of an electronic device 101 described with reference to FIGS. 1, 2A, 2B, 2C, 2D, 3A, 3B, 4A, 4B, FIG. 5, 6A, 7A, 7B, and 7C, and a structure of the electronic device 101 may be referenced.

In an embodiment, referring to an example 901 of FIG. 9, the electronic device 101 may obtain a user input 950, while displaying a screen including one or more areas (e.g., the area 911, the area 913, the area 915, the area 917, and the area 919) in a display area (e.g., an area 230a of FIG. 2A), in a first state (or a slide-in state). In an embodiment, in an area 911, a state bar may be displayed. In an embodiment, in the areas (e.g., the area 913, the area 915, and the area 917), a screen generated through one application (e.g., a messenger application) may be displayed. In an embodiment, in the area 913, conversations above an image object may be displayed. In an embodiment, in the area 915, the image object may be displayed. In an embodiment, in the area 917, conversations under the image object may be displayed. In an embodiment, in the area 919, a navigation bar may be displayed. In a screen 901 of FIG. 9, the state bar and the navigation bar are illustrated to be included, but this is only an example. According to an embodiment, in the first state, the screen displayed on the display area may not include the state bar and/or the navigation bar. In an embodiment, the image object included in the area 915 may include path information (e.g., a uniform resource locator (URL)) for obtaining content related to the image object.

In an embodiment, the electronic device 101 may identify content mapped to the image object of the area 915 in response to the user input 950. In an embodiment, the electronic device 101 may identify content hyperlinked to the image object of the area 915 in response to the user input 950. In an embodiment, the electronic device 101 may obtain content from an external device (e.g., a server 108, or an electronic device 102 and 103) in response to the user input 950 to the image object of the area 915. In an embodiment, the content mapped to the area 915 may be an original image of the image object of the area 915. In an embodiment, the image object of the area 915 may be a thumbnail image of the original image. However, it is not limited thereto.

In an embodiment, referring to an example 905 of FIG. 9, the electronic device 101 may display an area 916 including content obtained in a second state (or a slide-out state), in response to the user input 950. In an embodiment, the area 916 may be the enlarged area, according to a ratio of obtained content. In an embodiment, a ratio of the area 916 may be a ratio designated by an application 146 (or middleware 144) that generates a screen on which the area 916 is displayed.

In an embodiment, the electronic device 101 may enlarge the area 916, by moving at least one side among the sides (e.g., the side 721 and the side 725) of the area 916, while changing from the first state to the second state. In an embodiment, expanding the boundary of the area 916 may include moving at least one side among the sides (e.g., the side 721 and the side 725) of the area 916. For example, the electronic device 101 may enlarge upward the side 721 that is in contact with the upper area (e.g., the area 913) among the sides (e.g., the side 721 and the side 725) of the area 916, and may enlarge downward the side 725 that is in contact with the lower area (e.g., the area 917) among the sides (e.g., the side 721 and the side 725) of the area 916.

In an embodiment, referring to the example 905 of FIG. 9, the electronic device 101 may display the screen 910 arranged based on the area 916 including the obtained content in the second state, in response to the user input 950. In an embodiment, that the screen 910 is arranged based on the area 916 may mean that the area 916 displayed in the second state is displayed between other areas. In an embodiment, that the area 916 is displayed between the other areas may mean that areas where other contents are displayed are located in a letter box and/or a filler box generated as the area 916 is enlarged.

In an embodiment, referring to the example 905 of FIG. 9, the electronic device 101 may display the area 916 including obtained content in the area 915 in which the user input 950 is obtained, in response to the user input 950. While changing from the first state to the second state, the electronic device 101 may gradually enlarge the area 916 between the two areas (e.g., the area 913 and the area 917) facing each other along a direction (e.g., a second direction 262 of FIG. 2A) in which the display area is extended.

In an embodiment, in response to the user input 950, the electronic device 101 may gradually enlarge the area 915 in which the user input 950 is obtained between two areas (e.g., the area 913 and the area 917) facing each other, and then may display the area 916 instead of the area 915 in the second state. In an embodiment, the electronic device 101 may apply a designated graphic effect to the area 915 and/or the area 916 to display the area 916 instead of the area 915. For example, the electronic device 101 may apply a fade-out effect to the area 915, and may apply a fade-in effect to the area 916.

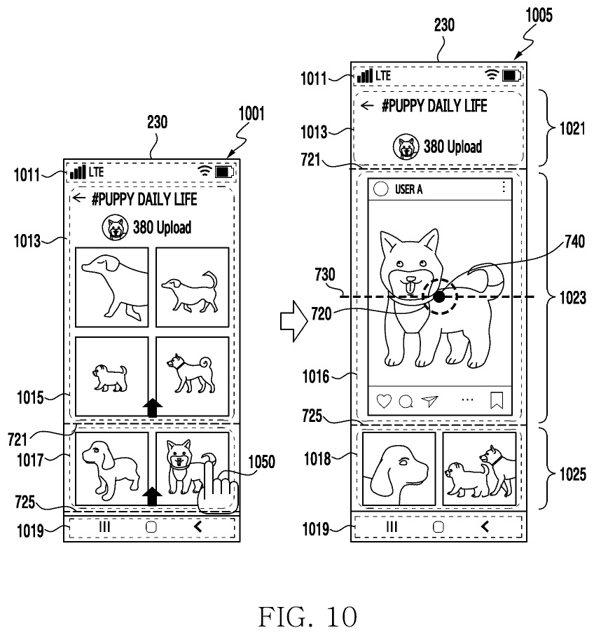

FIG. 10 is a diagram illustrating an example of a change in a layout of a UI according to a change from a reduced state to an extended state of an electronic device according to an embodiment.

For the description of FIG. 10, components of an electronic device 101 described with reference to FIGS. 1, 2A, 2B, 2C, 2D, 3A, 3B, 4A, 4B, FIG. 5, 6A, 7A, 7B, and 7C, and a structure of the electronic device 101 may be referenced.

In an embodiment, referring to an example 1001 of FIG. 10, the electronic device 101 may obtain a user input 1050, while displaying a screen including one or more areas (e.g., the area 1011, the area 1013, the area 1015, the area 1017, and the area 1019) in a display area (e.g., an area 230a of FIG. 2A), in a first state (or a slide-in state). In an embodiment, in an area 1011, a state bar may be displayed. In an embodiment, in the areas (e.g., the area 1013, the area 1015, and the area 1017), a screen generated through one application (e.g., a social network service (SNS) application) may be displayed. In an embodiment, in the area 1013, content of search information (e.g., #puppy daily life) may be displayed. In an embodiment, in the areas (e.g., the area 1015 and the area 1017), content including one or more thumbnail images may be displayed. In an embodiment, in the area 1019, a navigation bar may be displayed. In a screen 1001 of FIG. 10, the state bar and the navigation bar are illustrated to be included, but this is only an example. According to an embodiment, in the first state, the screen displayed on the display area may not include the state bar and/or the navigation bar.

In an embodiment, the electronic device 101 may identify one of contents included in an area 1017 in response to the user input 1050. In an embodiment, the electronic device 101 may identify a thumbnail image indicated by the user input 1050 among thumbnail images included in the area 1017. In an embodiment, the thumbnail image indicated by the user input 1050 may be content at a last position among content displayed on the screen.

In an embodiment, referring to an example 1005 of FIG. 10, the electronic device 101 may display an area 1016 including content selected in a second state (or a slide-out state), in response to the user input 1050. In an embodiment, the area 1016 may be the enlarged area, according to a ratio of selected content. In an embodiment, a ratio of the area 1016 may be a ratio designated by an application 146 (or middleware 144) that generates a screen on which the area 1016 is displayed.

In an embodiment, the electronic device 101 may enlarge the area 1016, by moving at least one side among the sides (e.g., the side 721 and the side 725) of the area 1016, while changing from the first state to the second state. In an embodiment, enlarging the boundary of the area 1016 may include moving at least one side among the sides (e.g., the side 721 and the side 725) of the area 1016. For example, the electronic device 101 may move the sides (e.g., the side 721 and the side 725) of the area 1016 upward.

In an embodiment, referring to the example 1005 of FIG. 10, the electronic device 101 may display the screen 1010 arranged based on the area 1016 including the selected content in the second state, in response to the user input 1050. In an embodiment, that the screen 1010 is arranged based on the area 1016 may mean that the area 1016 displayed in the second state is displayed between other areas. In an embodiment, that the area 1016 is displayed between the other areas may mean that areas where other contents are displayed are located in a letter box and/or a filler box generated as the area 1016 is enlarged.

In an embodiment, the electronic device 101 may display a new area 1018 below the area 1016 in the second state. In an embodiment, the new area 1018 may include next contents of the selected content.

In FIG. 10, it is exemplified that as the content of the last position is selected by the user input 1050, the new area 1018 including the next contents of the selected content is displayed, but this is only an example. According to an embodiment, as the content of the first position is selected by the user input 1050, a new area including previous content of the selected content may be displayed above the selected content.

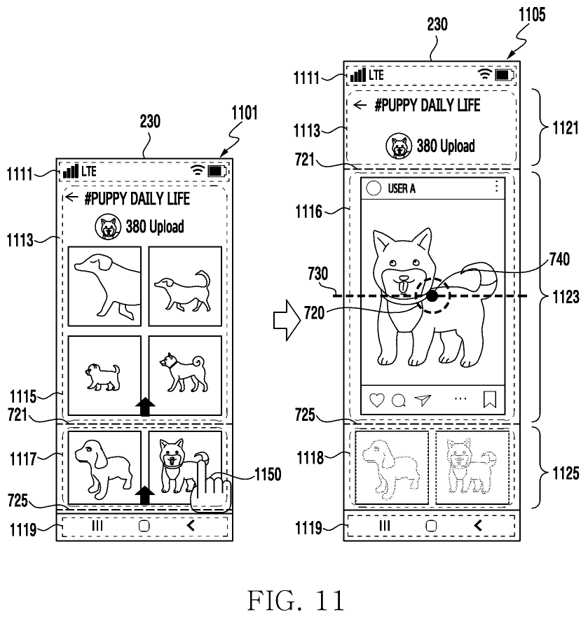

FIG. 11 is a diagram illustrating an example of a change in a layout of a UI according to a change from a reduced state to an extended state of an electronic device according to an embodiment.

For the description of FIG. 11, components of an electronic device 101 described with reference to FIGS. 1, 2A, 2B, 2C, 2D, 3A, 3B, 4A, 4B, FIG. 5, 6A, 7A, 7B, 7C, and 10, and a structure of the electronic device 101 may be referenced. Contents described in FIG. 10 may not be repeated in the description of FIG. 11.

Compared to FIG. 10, FIG. 11 may illustrate a situation in which there are no next contents of a selected content to be displayed in a new area 1118.

In an embodiment, referring to an example 1101 of FIG. 11, the electronic device 101 may obtain a user input 1150 while displaying a screen including one or more areas (e.g., the area 1111, the area 1113, the area 1115, the area 1117, and the area 1119) in a display area (e.g., an area 230a of FIG. 2A) in a first state (or a slide-in state). In an embodiment, in an area 1111, a state bar may be displayed. In an embodiment, in the areas (e.g., the area 1113, the area 1115, and the area 1117), a screen generated through one application (e.g., a SNS application) may be displayed. In an embodiment, in the area 1113, content of search information (e.g., #puppy daily life) may be displayed. In an embodiment, in the areas (e.g., the area 1115 and the area 1117), content including one or more thumbnail images may be displayed. In an embodiment, in the area 1119, a navigation bar may be displayed. In a screen 1101 of FIG. 11, the state bar and the navigation bar are illustrated to be included, but this is only an example. According to an embodiment, in the first state, the screen displayed on the display area may not include the state bar and/or the navigation bar.

In an embodiment, the electronic device 101 may identify one of contents included in an area 1117 in response to the user input 1150. In an embodiment, the electronic device 101 may identify a thumbnail image indicated by the user input 1150 among thumbnail images included in the area 1117. In an embodiment, the thumbnail image indicated by the user input 1150 may be content at a last position among content displayed on the screen.

In an embodiment, referring to an example 1105 of FIG. 11, the electronic device 101 may display an area 1116 including content selected in a second state (or a slide-out state), in response to the user input 1050.

In an embodiment, the electronic device 101 may enlarge the area 1116, by moving at least one side among the sides (e.g., the side 721 and the side 725) of the area 1116, while changing from the first state to the second state. In an embodiment, expanding the boundary of the area 1116 may include moving at least one side among the sides (e.g., the side 721 and the side 725) of the area 1116. For example, the electronic device 101 may move the sides (e.g., the side 721 and the side 725) of the area 1116 upward.

In an embodiment, referring to the example 1105 of FIG. 10, the electronic device 101 may display the screen 1110 arranged based on the area 1116 including the selected content in the second state, in response to the user input 1150.

In an embodiment, the electronic device 101 may display the new area 1118 below the area 1116 in the second state. In an embodiment, the electronic device 101 may determine whether there are next contents of the selected content to be displayed in the new area 1118. In an embodiment, in case that there are no next contents of the selected content to be displayed in the new area 1118, the electronic device 101 may display contents included in an area (e.g., the area 1117) displayed in the first state in the new area 1118. In an embodiment, in case that there are no next contents of the selected content to be displayed in the new area 1118, the electronic device 101 may display the new area 1118 in a state in which a designated effect is applied to contents included in an area (e.g., area 1117) displayed in the first state. In an embodiment, the designated effect may be a blur effect. However, it is not limited thereto.

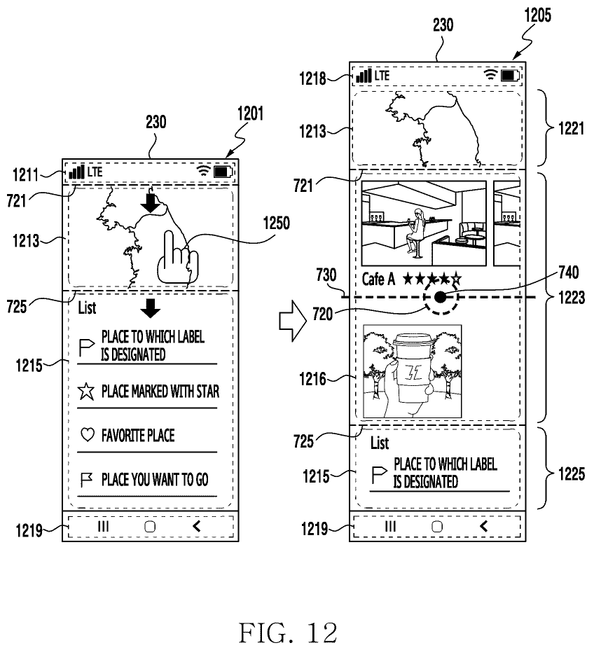

FIG. 12 is a diagram illustrating an example of a change in a layout of a UI according to a change from a reduced state to an extended state of an electronic device according to an embodiment.

For the description of FIG. 12, components of an electronic device 101 described with reference to FIGS. 1, 2A, 2B, 2C, 2D, 3A, 3B, 4A, 4B, FIG. 5, 6A, 7A, 7B, and 7C, and a structure of the electronic device 101 may be referenced.

In an embodiment, referring to an example 1201 of FIG. 12, the electronic device 101 may obtain a user input 1250, while displaying a screen including one or more areas (e.g., the area 1211, the area 1213, the area 1215, and the area 1219) in a display area (e.g., an area 230a of FIG. 2A), in a first state (or a slide-in state). In an embodiment, in an area 1211, a state bar may be displayed. In an embodiment, in the areas (e.g., the area 1213 and the area 1215), a screen generated through one application (e.g., a map application) may be displayed. In an embodiment, in the area 1213, a map may be displayed. In an embodiment, in the area 1215, content including a list for places may be displayed. In an embodiment, in the area 1219, a navigation bar may be displayed. In a screen 1201 of FIG. 12, the state bar and the navigation bar are illustrated to be included, but this is only an example. According to an embodiment, in the first state, the screen displayed on the display area may not include the state bar and/or the navigation bar.

In an embodiment, the electronic device 101 may identify one of contents included in an area 1213 in response to the user input 1250. In an embodiment, the electronic device 101 may identify position information for a position indicated by the user input 1250 among positions included in the area 1213. In an embodiment, the area 1213 where the user input 1250 is identified may be an area at a first position among areas displayed on the screen.

In an embodiment, referring to an example 1205 of FIG. 12, the electronic device 101 may display an area 1216 including content (e.g., the position information) selected in a second state (or a slide-out state), in response to the user input 1250. In an embodiment, the area 1216 may be the enlarged area, according to a ratio of selected content. In an embodiment, a ratio of the area 1216 may be a ratio designated by an application 146 (or middleware 144) that generates a screen on which the area 1216 is displayed.

In an embodiment, the electronic device 101 may enlarge the area 1216, by moving at least one side among the sides (e.g., the side 721 and the side 725) of the area 1216, while changing from the first state to the second state. In an embodiment, enlarging the boundary of the area 1216 may include moving at least one side among the sides (e.g., the side 721 and the side 725) of the area 1216. For example, the electronic device 101 may move the sides (e.g., the side 721 and the side 725) of the area 1216 upward.

In an embodiment, referring to the example 1205 of FIG. 12, the electronic device 101 may display the screen 1210 arranged based on the area 1216 including the selected content in the second state, in response to the user input 1250. In an embodiment, that the screen 1210 is arranged based on the area 1216 may mean that the area 1216 displayed in the second state is displayed between other areas. In an embodiment, that the area 1216 is displayed between the other areas may mean that areas where other contents are displayed are located in a letter box and/or a filler box generated as the area 1216 is enlarged.

In an embodiment, the electronic device 101 may display a partial area (e.g., the area 1215) among the areas (e.g., the area 1215) that are not selected in the first state, below the area 1216 in the second state. In an embodiment, the electronic device 101 may display the area 1215 displayed below the area 1213 selected in the first state, below the area 1216 in the second state. In an embodiment, a size of the area 1215 displayed in the second state may become smaller than a size in the first state. In an embodiment, the area 1215 displayed in the second state may include some (e.g., a ‘place to which a label is designated’) of the content included in the area 1215 displayed in the first state.

In an embodiment, the electronic device 101 may display a new area 1218 above the area 1216 in the second state. In an embodiment, the electronic device 101 may determine whether there is content before the content of the area 1213 in which the user input 1250 is identified. In an embodiment, in case that there is no previous content to be displayed in the new area 1218, the electronic device 101 may display content displayed in the first state in the new area 1218. In an embodiment, in case that there are no previous contents of the selected content to be displayed in the new area 1218, the electronic device 101 may display the new area 1218 in a state in which a designated effect is applied to contents included in an area (e.g., the area 1213) displayed in the first state. In an embodiment, the designated effect may be a blur effect. However, it is not limited thereto.

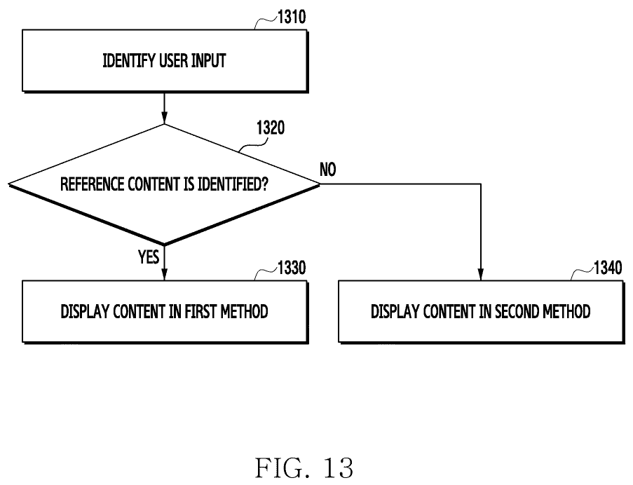

FIG. 13 is a flowchart illustrating an operation of an electronic device according to an embodiment.

For the description of FIG. 13, components of an electronic device 101 described with reference to FIGS. 1, 2A, 2B, 2C, 2D, 3A, 3B, 4A, 4B, FIG. 5, 6A, 7A, 7B, and 7C, and a structure of the electronic device 101 may be referenced.

Referring to FIG. 13, in operation 1310, the electronic device 101 may identify a user input. In an embodiment, the electronic device 101 may identify an input for selecting one content (e.g., content in an area 613) among one or more areas (e.g., the area 611, the area 613, and the area 615) displayed in the first state. In an embodiment, the electronic device 101 may identify an input for changing a display area (e.g., an area 230a of FIG. 2A) of a display 230 to an enlarged second state, in a first state (or a slide-in state). In an embodiment, a screen 610 including one or more areas (e.g., the area 611, the area 613, and the area 615) may be displayed on the area 230a. The one or more areas (e.g., the area 611, the area 613, and the area 615) may be arranged along a direction (e.g., a second direction 262 of FIG. 2A) in which the display area of the display 230 is extended. However, it is not limited thereto. In an embodiment, the one or more areas (e.g., the area 611, the area 613, and the area 615) in the screen 610 may be disposed according to various layouts (e.g., linear layout, relative layout, frame layout, constraint layout, grid layout, and table layout). In an embodiment, at least one content may be included in each of the one or more areas (e.g., the area 611, the area 613, and the area 615) in the screen 610. In an embodiment, the at least one content may include a visual object. In an embodiment, the visual object may include text, an image, and/or a video.

In an embodiment, the identified user input may include an input for selecting one content (e.g., the content in the area 613) among the one or more areas (e.g., the area 611, the area 613, and the area 615) displayed in the first state. In an embodiment, the identified user input may include an input for requesting a change from the first state to the second state. In an embodiment, the identified user input may include an input for selecting one content (e.g., the content in the area 613) and requesting the change to the second state.

In operation 1320, the electronic device 101 may identify reference content. In an embodiment, the electronic device 101 may determine whether the reference content is identified based on the identified user input.

In an embodiment, in case that the identified user input includes an input for selecting one content (e.g., the content in the area 613) among the one or more areas (e.g., the area 611, the area 613, and the area 615) displayed in the first state, the electronic device 101 may identify the selected content as the reference content. In an embodiment, in case that the identified user input includes the input for requesting the change from the first state to the second state, the electronic device 101 may identify content located in a designated area (e.g., an area 613 located in the middle) among the one or more areas (e.g., the area 611, the area 613, and the area 615) displayed in the first state as the reference content. The operation of identifying the content located in the designated area (e.g., the area 613 located in the middle) as the reference content may be performed in case that a function for automatic identification is turned on. However, it is not limited thereto.

In an embodiment, in case that the reference content is identified, the electronic device 101 may perform operation 1330. In an embodiment, in case that the reference content is not identified, the electronic device 101 may perform operation 1340. In an embodiment, the reference content may not be identified in case that the user requests only the enlargement of the area 230a without the input for selecting the content. In an embodiment, the reference content may not be identified in case that the user requests only the enlargement of the area 230a without the input for selecting the content in a state that the function for automatic identification is turned off.

In operation 1330, the electronic device 101 may display the content in a first method. In an embodiment, the first method may refer to a method of placing an area including the selected content in a center area among a plurality of areas arranged along the direction (e.g., the second direction 262 of FIG. 2A) in which the display area of the area 230c of the second state is extended.

In an embodiment, the electronic device 101 may enlarge the area including the selected content, according to a ratio (or aspect ratio) of the selected content. In an embodiment, the electronic device 101 may enlarge the area including the selected content by enlarging the boundary of the area including the selected content, while changing from the first state to the second state.

In an embodiment, the electronic device 101 may locate the area including the selected content at a center position 740 of the display area (e.g., the area 230c of FIG. 2C) in the second state. In an embodiment, while changing from the first state to the second state, the electronic device 101 may move the area including the selected content, in order to locate the area including the selected content at the center position 740 of the display area (e.g., the area 230c of FIG. 2C) in the second state.

In an embodiment, the electronic device 101 may display a partial area among the area that are not selected in the first state, around the area including content selected in the second state. In an embodiment, a periphery of the area including the selected content may be an area of a letter box and/or a filler box.

In operation 1340, the electronic device 101 may display content in a second method.

In an embodiment, displaying the content in the second method may refer to enlarging the screen displayed in the first state according to the direction (e.g., the second direction 262 of FIG. 2A) in which the display area of the display 230 is extended.

In an embodiment, displaying the content in the second method may refer to displaying an additional screen on the screen displayed in the first state. The additional screen may be displayed in a display area added as it changes from the first state to the second state. In an embodiment, the screen displayed in the first state may be displayed in the second state with the same size. However, it is not limited thereto.

In an embodiment, according to the setting of the electronic device 101, the electronic device 101 may display connection content (e.g., hyperlink execution) for the selected content in operation 1310 without changing to the second state.

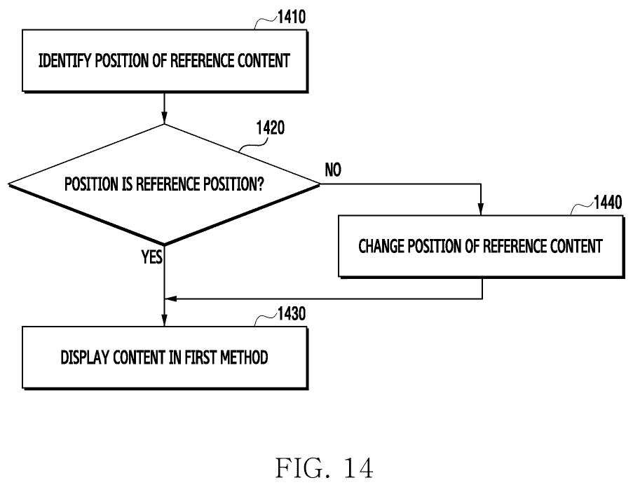

FIG. 14 is a flowchart illustrating an operation of an electronic device according to an embodiment.

For the description of FIG. 14, components of an electronic device 101 described with reference to FIGS. 1, 2A, 2B, 2C, 2D, 3A, 3B, 4A, 4B, FIG. 5, 6A, 7A, 7B, and 7C, and a structure of the electronic device 101 may be referenced. Operations 1410, 1420, 1430, and 1440 of FIG. 14 may be included in operation 1330 of FIG. 13.

Referring to FIG. 14, in operation 1410, the electronic device 101 may identify a position of reference content. In an embodiment, the reference content may be one content (e.g., content in an area 613) identified by a user input. In an embodiment, in case that the user input includes an input for requesting a change from the first state to the second state, the reference content may be content located in a designated area (e.g., an area 613 located in the middle) among one or more areas (e.g., the area 611, the area 613, and the area 615) displayed in the first state. However, it is not limited thereto.

In operation 1420, the electronic device 101 may determine whether the position of the reference content is the reference position. In an embodiment, the reference position may be a center position 740 or a position of an area including the center position 740 among a plurality of areas arranged along a direction (e.g., a second direction 262 of FIG. 2A) in which a display area of a display 230 is extended, in an area 230a in the first state.

In an embodiment, in case that the position of the reference content is the reference position, the electronic device 101 may perform operation 1430. In an embodiment, in case that the position of the reference content is not the reference position, the electronic device 101 may perform operation 1440.

In operation 1430, the electronic device 101 may display content in the first method. In an embodiment, the first method may refer to a method of placing an area including the selected content in the center area among a plurality of areas arranged along the direction (e.g., the second direction 262 of FIG. 2A) in which the display area of the area 230c in the second state is extended.

In an embodiment, the electronic device 101 may enlarge the area including the selected content according to a ratio (or aspect ratio) of the selected content. In an embodiment, the electronic device 101 may enlarge the area including the selected content by enlarging the boundary of the area including the selected content, while changing from the first state to the second state.

In an embodiment, the electronic device 101 may display a partial area among the area that are not selected in the first state, around the area including content selected in the second state. In an embodiment, a periphery of the area including the selected content may be an area of a letter box and/or a filler box.

In operation 1440, the electronic device 101 may change the position of the reference content.

In an embodiment, the electronic device 101 may locate the area including the selected content at the center position 740 of the display area (e.g., the area 230c of FIG. 2C) in the second state. In an embodiment, while changing from the first state to the second state, the electronic device 101 may move the area including the selected content, in order to locate the area including the selected content at the center position 740 of the display area (e.g., the area 230c of FIG. 2C) in the second state.

In FIG. 14, operations 1430 and 1440 are illustrated as separate operations, but this is only an example. The operations 1430 and 1440 may be performed simultaneously. For example, the electronic device 101 may enlarge the size of the area including the selected content while moving the area including the selected content to the center position 740.

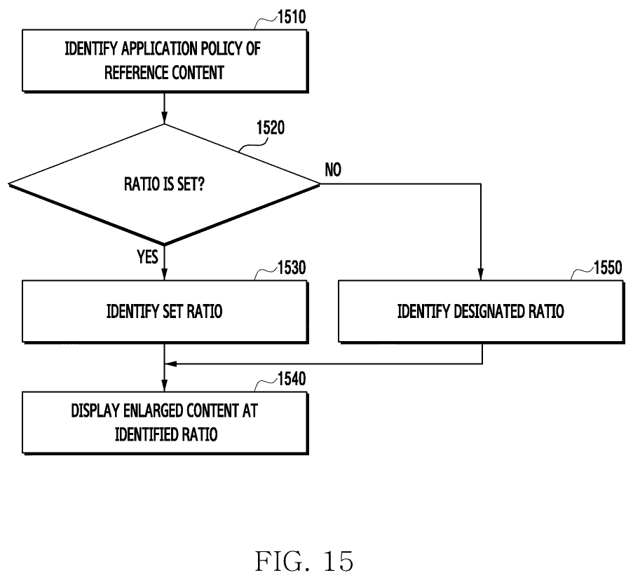

FIG. 15 is a flowchart illustrating an operation of an electronic device according to an embodiment.

For the description of FIG. 15, components of an electronic device 101 described with reference to FIGS. 1, 2A, 2B, 2C, 2D, 3A, 3B, 4A, 4B, FIG. 5, 6A, 7A, 7B, and 7C, and a structure of the electronic device 101 may be referenced.

Referring to FIG. 15, in operation 1510, the electronic device 101 may identify an application policy of reference content. In an embodiment, the application policy may be a policy set by an application displaying the reference content, with respect to the reference content. For example, the policy may include a display method, a display ratio, and/or a layout of the reference content.

In operation 1520, the electronic device 101 may determine whether the ratio is set. In an embodiment, the electronic device 101 may determine whether a ratio related to display of the reference content is set in the application policy. In an embodiment, in case that the ratio related to display of the reference content is set in the application policy, the electronic device 101 may perform operation 1530. In an embodiment, in case that the ratio related to display of the reference content is not set in the application policy, the electronic device 101 may perform operation 1550.

In operation 1530, the electronic device 101 may identify the set ratio. In an embodiment, the electronic device 101 may identify a ratio (or aspect ratio) set with respect to the reference content according to the application policy.

In operation 1540, the electronic device 101 may display the enlarged content at the identified ratio. Here, displaying the enlarged content at the identified ratio may mean displaying the content at a maximum size that does not deviate from the display area (e.g., the area 230c of FIG. 2C) in the second state.

In operation 1550, the electronic device 101 may identify a designated ratio. In an embodiment, the electronic device 101 may identify a ratio (or aspect ratio) designated with respect to the reference content in the operating system (or middleware).

As described above, the electronic device 101 may comprise a housing comprising a first housing part 210 and a second housing part 220 movably engaged with the first housing part 210 along an axis. The electronic device 101 may comprise a display 230 (e.g., a flexible display) in which a size of a display area visible from the front of the electronic device is enlarged or reduced in the first direction 261 and the second direction 262, according to a movement of the second housing part 220. The electronic device 101 may comprise a memory 130 storing instructions. The electronic device 101 may comprise a processor 120 operatively connected to the display 230 and the memory 130. The instructions may be configured, when executed by the processor 120, to cause the electronic device to, while the size of the display area of the display 230 has a first size, display a plurality of contents in the display area. The instructions may be configured, when executed by the processor 120, to cause the electronic device to, as the size of the display area increases from the first size to the second size in the first direction 261 and the second direction 262, display first content related to content selected from among the plurality of contents in a first area (e.g., the area 613) among areas (e.g., the area 611, the area 613, and the area 615) which are divided along the axis direction in the display area with the second size. The instructions may be configured, when executed by the processor 120, to cause the electronic device to, as the size of the display area increases from the first size to the second size in the first direction 261 and the second direction 262, display, in a second area (e.g., the area 611) and a third area (e.g., the area 615) which are adjacent to the first area (e.g., the area 613) along the axis direction and put the first area (e.g., the area 613) therebetween, at least a part of second content and at least a part of third content which are arranged around the selected content, respectively.

The first area (e.g., the area 613) where the first content is displayed may be larger than an area where the selected content is displayed in the display area with the first size.

The first area (e.g., the area 613) where the first content is displayed may be enlarged from an area where the selected content is displayed in the display area with the first size.

The first content may be obtained from an external electronic device based on the selection of the selected content.

The instructions may be configured, when executed by the processor 120, to cause the electronic device to obtain user input 751. The instructions may be configured, when executed by the processor 120, to cause the electronic device to select content corresponding to a position where the user input 751 is obtained among the plurality of contents.

The instructions may be configured, when executed by the processor 120, to cause the electronic device to obtain a user input 751 requesting to enlarge the size of the display area from the first size to the second size in the first direction 261 and the second direction 262. The instructions may be configured, when executed by the processor 120, to cause the electronic device to select content located in a designated area among the plurality of contents displayed in different areas divided along the axis direction in the display area with the first size.

The first area (e.g., the area 613) of the first content may include a center position of the display area with the second size.

The instructions may be configured, when executed by the processor 120, to cause the electronic device to, while the size of the display area is enlarged from the first size to the second size, move the at least a part of the second content and the at least a part of the third content which are arranged around the selected content, respectively, for the first area (e.g., the area 613) to be located between the second area (e.g., the area 611) and the third area (e.g., the area 615).

The plurality of contents may include one or more visual objects.

When the selected content is one image object, an aspect ratio of the first area (e.g., the area 613) where the first content is displayed may correspond to an aspect ratio of the image object.

The lengths of the two areas (e.g., the area 611 and the area 615) in the axis direction may be equal to each other.

The second content may include a portion of any one content among a plurality of contents displayed in the display area with the first size.

The second content may be distinguished from a plurality of contents displayed in the display area of the first size.

The second area (e.g., the area 611) and the third area (e.g., the area 615) corresponding to the second content and the third content, respectively, may be distinguished along the axis direction. As the size of the display area increases from the first size to the second size in the first direction 261 and the second direction 262, the first area (e.g., the area 613) may be enlarged between the two other areas (e.g., among the area 611, the area 613, and the area 615).

One area among the two other areas (e.g., among the area 611, the area 613, and the area 615) may include a center position of the display area with the first size.

The instructions may be configured, when executed by the processor 120, to cause the electronic device to, while the size of the display area is enlarged from the first size to the second size in the first direction 261 and the second direction 262, display the selected content in the first area (e.g., the area 613). The instructions may be configured, when executed by the processor 120, to cause the electronic device to change the content displayed in the first area (e.g., the area 613) from the selected content to the first content, in response to the fact that the size of the display area has the second size in the first direction 261 and the second direction 262.

As described above, the method may be executed by an electronic device including a housing comprising a first housing part 210 and a second housing part 220 movably engaged with the first housing part 210 along an axis, and a display 230 (e.g., a flexible display) in which a size of a display area visible from the front of the electronic device is enlarged or reduced in the first direction 261 and the second direction 262, according to a movement of the second housing part 220. The method may comprise, while the size of the display area of the display 230 has a first size, displaying a plurality of contents in the display area. The method may comprise, as the size of the display area increases from the first size to the second size in the first direction 261 and the second direction 262, displaying first content related to content selected from among the plurality of contents in a first area (e.g., the area 613) among areas (e.g., the area 611, the area 613, and the area 615) which are divided along the axis direction in the display area with the second size. The method may comprise, as the size of the display area increases from the first size to the second size in the first direction 261 and the second direction 262, displaying, in a second area (e.g., the area 611) and a third area (e.g., the area 615) which are adjacent to the first area (e.g., the area 613) along the axis direction and put the first area (e.g., the area 613) therebetween, at least a part of second content and at least a part of third content which are arranged around the selected content, respectively.

The method may comprise obtaining a user input 751 requesting to enlarge the size of the display area from the first size to the second size in the first direction 261 and the second direction 262. The method may comprise selecting content located in a designated area among the plurality of contents displayed in different areas divided along the axis direction in the display area with the first size.

The method may comprise, while the size of the display area is enlarged from the first size to the second size, moving the at least a part of the second content and the at least a part of the third content which are arranged around the selected content, respectively, for the first area (e.g., the area 613) to be located between the second area (e.g., the area 611) and the third area (e.g., the area 615).

The second area (e.g., the area 611) and the third area (e.g., the area 615) corresponding to the second content or the third content, respectively, are divided along the axis direction. As the size of the display area increases from the first size to the second size in the first direction 261 and the second direction 262, the first area (e.g., the area 613) may be enlarged between the two other areas (e.g., among the area 611, the area 613, and the area 615).

As described above, the non-transitory computer readable storage medium may store program including instructions. The instructions may be configured, when executed by a processor 120 of an electronic device including a housing comprising a first housing part 210 and a second housing part 220 movably engaged with the first housing part 210 along an axis, and a display 230 (e.g., a flexible display) in which a size of a display area visible from the front of the electronic device is enlarged or reduced in the first direction 261 and the second direction 262, according to a movement of the second housing part 220, to cause the electronic device to, while the size of the display area of the display 230 has a first size, display a plurality of contents in the display area. The instructions may be configured, when executed by the processor, to cause the electronic device to, as the size of the display area increases from the first size to the second size in the first direction 261 and the second direction 262, display first content related to content selected from among the plurality of contents in a first area (e.g., the area 613) among areas (e.g., the area 611, the area 613, and the area 615) which are divided along the axis direction in the display area with the second size. The instructions may be configured, when executed by the processor, to cause the electronic device to, as the size of the display area increases from the first size to the second size in the first direction 261 and the second direction 262, display, in a second area (e.g., the area 611) and a third area (e.g., the area 615) which are adjacent to the first area (e.g., the area 613) along the axis direction and put the first area (e.g., the area 613) therebetween, at least a part of second content and at least a part of third content which are arranged around the selected content, respectively.

The instructions may be configured to, when executed by the processor 120, cause the electronic device to obtain a user input 751 requesting to enlarge the size of the display area from the first size to the second size in the first direction 261 and the second direction 262. The instructions may be configured to, when executed by the processor 120, cause the electronic device to select content located in a designated area among the plurality of contents displayed in different areas divided along the axis direction in the display area with the first size.

The instructions may be configured to, when executed by the processor 120, cause the electronic device to, while the size of the display area is enlarged from the first size to the second size, move the at least a part of the second content and the at least a part of the third content which are arranged around the selected content, respectively, for the first area (e.g., the area 613) to be located between the second area (e.g., the area 611) and the third area (e.g., the area 615).

The second area (e.g., the area 611) and the third area (e.g., the area 615) corresponding to the second content or the third content, respectively, may be divided each other along the axis direction. As the size of the display area increases from the first size to the second size in the first direction 261 and the second direction 262, the first area (e.g., the area 613) may be enlarged between the two other areas (e.g., among the area 611, the area 613, and the area 615).

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the present disclosure, the electronic devices are not limited to those described above.

It should be appreciated that the example embodiments described in the present disclosure and the terms used therein are not intended to limit the present disclosure to particular embodiments, and the scope of the present disclosure includes various changes, equivalents, and/or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the present disclosure, the term “module” may include a unit implemented in hardware, software, or firmware, and may interchangeably be used with other terms, for example, “logic,” “logic block,” “part,” or “circuitry.” A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the present disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device, comprising:
a housing comprising a first housing part and a second housing part movably engaged with the first housing part;
a flexible display comprising a display area visible from a front of the electronic device, wherein a size of the display area is enlarged or reduced according to a movement of the second housing part;
a memory storing instructions; and
a processor operatively connected to the flexible display and the memory,
wherein the instructions are configured to, when executed by the processor, cause the electronic device to:
display a plurality of contents in the display area while the size of the display area of the flexible display is a first size; and
based on the size of the display area increasing from the first size to a second size:
display, in a first area among areas of the display area, first content related to content selected from among the plurality of contents while the display area has the first size, wherein the areas are arranged with respect to each other; and
display, in a second area and a third area among the areas, at least a part of second content and at least a part of third content, respectively,
wherein the first area is between and adjacent to the second area and the third area, and
wherein the at least the part of the second content and the at least the part of the third content are respectively displayed, while the size of the display area is increasing to the second size, around where the content that is selected was displayed while the display area has the first size.

2. The electronic device of claim 1, wherein the first area where the first content is displayed, while the size of the display area is increasing to the second size, is larger than an area where the content, that is selected, is displayed in the display area while the display area has the first size.

3. The electronic device of claim 1, wherein the first area where the first content is displayed, while the size of the display area is increasing to the second size, is enlarged from an area where the content, that is selected, is displayed in the display area while the display area has the first size.

4. The electronic device of claim 1, wherein the instructions are configured to, when executed by the processor, cause the electronic device to obtain the first content from an external electronic device based on the content being selected.

5. The electronic device of claim 1, wherein the instructions are configured to, when executed by the processor, cause the electronic device to:
obtain a user input, and
select content, among the plurality of contents, corresponding to a position where the user input is obtained.

6. The electronic device of claim 1, wherein the instructions are configured to, when executed by the processor, cause the electronic device to:
obtain a user input requesting to enlarge the size of the display area from the first size to the second size; and
select content located in a designated area among the plurality of contents displayed in the display area while the display area has the first size,
wherein the plurality of contents are displayed in respective areas of the display area, while the display area has the first size, and
wherein the respective areas are arranged with respect to each other.

7. The electronic device of claim 1, wherein the first area includes a center position of the display area, while the display area has the second size.

8. The electronic device of claim 1, wherein the instructions are configured, when executed by the processor, cause the electronic device to:
move, while the size of the display area is enlarged from the first size to the second size, the at least the part of the second content and the at least the part of the third content, that are respectively arranged around the content, that is selected, such that the first area is between the second area and the third area.

9. The electronic device of claim 1, wherein the plurality of contents comprise one or more visual objects.

10. The electronic device of claim 9, wherein the content, that is selected, is an image object, and an aspect ratio of the first area where the first content is displayed is the same as an aspect ratio of the image object.

11. The electronic device of claim 1, wherein the second content comprises a portion of one content among the plurality of contents displayed in the display area while the display area has the first size.

12. The electronic device of claim 1, wherein the instructions are configured, when executed by the processor, cause the electronic device to enlarge the first area between the second area and the third area as the size of the display area increases from the first size to the second size.

13. A method performed by an electronic device including a housing including a first housing part and a second housing part movably engaged with the first housing part, and a flexible display including a display area visible from a front of the electronic device, wherein a size of the display area is enlarged or reduced according to a movement of the second housing part, the method comprising:
displaying a plurality of contents in the display area while the size of the display area of the flexible display is a first size; and
based on the size of the display area increasing from the first size to a second size:
displaying, in a first area among areas of the display area, first content related to content selected from among the plurality of contents while the display area has the first size, wherein the areas are arranged with respect to each other; and
displaying, in a second area and a third area among the areas, at least a part of second content and at least a part of third content, respectively,
wherein the first area is between and adjacent to the second area and the third area, and
wherein the at least the part of the second content and the at least the part of the third content are respectively displayed, while the size of the display area is increasing to the second size, around where the content that is selected was displayed while the display area has the first size.

14. The method of claim 13, comprising
obtaining a user input requesting to enlarge the size of the display area from the first size to the second size; and
selecting content located in a designated area among the plurality of contents displayed in the display area while the display area has the first size,
wherein the plurality of contents are displayed in respective areas of the display area, while the display area has the first size, and
wherein the respective areas are arranged with respect to each other.

15. The method of claim 13, comprising
moving, while the size of the display area is enlarged from the first size to the second size, the at least the part of the second content and the at least the part of the third content, that are respectively arranged around the content, that is selected, such that the first area is located between the second area and the third area.

16. The method of claim 13, comprising enlarging the first area between the second area and the third area as the size of the display area increases from the first size to the second size.

17. A non-transitory computer readable storage medium storing a program including instructions, wherein the instructions are configured to, when executed by a processor of an electronic device including a housing including a first housing part and a second housing part movably engaged with the first housing part, and a flexible display including a display area visible from a front of the electronic device, wherein a size of the display area is enlarged or reduced according to a movement of the second housing part, cause the electronic device to:
display a plurality of contents in the display area while the size of the display area of the flexible display is a first size; and
based on the size of the display area increasing from the first size to a second size:
display, in a first area among areas of the display area, first content related to content selected from among the plurality of contents while the display area has the first size, wherein the areas are arranged with respect to each other; and
display, in a second area and a third area among the areas, at least a part of second content and at least a part of third content, respectively,
wherein the first area is between and adjacent to the second area and the third area, and
wherein the at least the part of the second content and the at least the part of the third content are respectively displayed, while the size of the display area is increasing to the second size, around where the content that is selected was displayed while the display area has the first size.

18. The non-transitory computer readable storage medium of claim 17, wherein the instructions are further configured to, when executed by the processor, cause the electronic device to:
obtain a user input requesting to enlarge the size of the display area from the first size to the second size; and
select content located in a designated area among the plurality of contents displayed in the display area while the display area has the first size,
wherein the plurality of contents are displayed in respective areas of the display area, while the display area has the first size, and
wherein the respective areas are arranged with respect to each other.

19. The non-transitory computer readable storage medium of claim 17, wherein the instructions are further configured to, when executed by the processor, cause the electronic device to:
move, while the size of the display area is enlarged from the first size to the second size, the at least the part of the second content and the at least the part of the third content, that are respectively arranged around the content, that is selected, such that the first area is located between the second area and the third area.

20. The non-transitory computer readable storage medium of claim 17, wherein the instructions are further configured to, when executed by the processor, cause the electronic device to enlarge the first area between the second area and the third area as the size of the display area increases from the first size to the second size.
